(19) United States
(12) Patent Application Publication
(10) Pub. No.: US 2024/0186093 A1
(43) Pub. Date: Jun. 6, 2024

(54) Relay Bypass Mechanism

(71) Applicant: Solaredge Technologies Ltd., Herzeliya (IL)

(72) Inventors: Vyacheslav Gak, Or Akiva (IL); Gilad Reshef, Tel-Aviv (IL)

(21) Appl. No.: 18/522,435

(22) Filed: Nov. 29, 2023

Related U.S. Application Data
(60) Provisional application No. 63/429,205, filed on Dec. 1, 2022.

(51) Int. Cl. H01H 47/00; H01H 50/54

(52) U.S. Cl. CPC H01H 47/001; H01H 50/54

(57) ABSTRACT

Switch device including a switch and a bypass mechanism and a method of manually operating the switch. The switch includes a first terminal, a second terminal, a contact member configured to be in a first position and a second position and to form a connection between the first terminal and the second terminal when in the first position or in the second position, and a control unit configured to facilitate a transition of the contact member and to retain the contact member at the first position or at the second position in the absence of an external force. The bypass mechanism includes at least one moveable member having a first surface configured to contact the contact member at a first angle that is acute or obtuse. Energy generation and/or storage systems contain the switch device, and methods of controlling connection of these systems to a power grid and/or a load.

### CROSS-REFERENCE TO RELATED APPLICATIONS

This application claims the benefit of U.S. Provisional Application No. 63/429,205, filed on Dec. 1, 2022. The above-referenced application is hereby incorporated by reference in its entirety.

### BACKGROUND

The present disclosure relates to a mechanical bypass mechanism for an electromagnetic switch.

A relay is an electromagnetically operated switch. It generally consists of a set of input terminals for a single or multiple control signals, and a set of operating contact terminals. The switch may have any number of contacts in multiple contact forms, such as make contacts, break contacts, or combinations thereof. Typically, a relay uses an electromagnet, such as a coil, to close or open the contacts, but relays based on other operating principles also exist, such as in solid-state relays which use semiconductor properties for control without relying on moving parts.

A latching relay is a two-positional electromechanical switch that is configured to maintain either contact position indefinitely without power applied to the coil. The coil of the latching relay consumes power only while the relay is switched on, thereby changing the contact position of the relay. After the switch has been released by shutting down the power supplied to the coil, its contact remains in the same position. One of the advantages of the latching relay is that one coil consumes power only for an instant while the relay is being switched, and the relay contacts retain this setting across a power outage.

In some electrical applications, an electrical device (e.g., a power generation circuit) may comprise, according to standards and regulations, an automatic switching circuit (e.g., a circuit breaker). The automatic switching circuit may disconnect the electrical device from a power grid (e.g., distribution grid, distributed generator, or microgrid), and a load or electric panel, based on an interruption or a fault (e.g., high current, high voltage, unintentional feeding of the circuitry into a sub grid or a stand-alone grid) detected by a control circuit. Whole-home backup from a battery energy storage system also requires an automated means of disconnecting the home from the distribution grid to allow back up, or switching from the back up mode to the power generating device when there is enough wattage therein. A latching relay or an array of latching relays may be used in such electrical applications for controlling connection between the power generation or storage devices, electric panel of the user and the distribution grid.

The relay array may comprise a plurality of relay legs and a control circuit. Each relay leg may connect between an output of the power generation or storage device and a power grid or a load. Each of the relay legs may feature at least two relays, to ensure a disconnection of the grid or load even in the event of a damaged or inactive relay. Each of the relays may comprise a contact member that may be controlled by a control coil, such that when an electric current is passed through the control coil a magnetic field may be generated to activate a mechanism (e.g., an electromechanical mechanism such as an electromagnet) that controls the contact member, thereby making or breaking a connection of the contact member (e.g., changing the contact member configuration).

### BRIEF SUMMARY OF THE INVENTION

The following presents a simplified summary of disclosed aspects in order to provide a basic understanding of these aspects. This summary is not an extensive overview of the aspects. It is not intended to identify key or critical elements or to delineate the scope of the disclosure.

Aspects of the disclosure relate to an apparatus (also termed herein “switch device”) comprising a switch and a bypass mechanism. The switch is configured to connect and disconnect two terminals and to remain in said connected or disconnected mode in the absence of an external force. The bypass mechanism allows to circumvent said switch, for example, if it fails to perform the required connection of disconnection of the terminals. The bypass mechanism may apply external force to disconnect the terminals when the switch remains in the connected mode and connect the terminals when the switch remains in the disconnected mode.

The switch may be in a form of a latching relay that is controlled by an electromagnetic component, such as a coil, and the bypass mechanism may be based on a mechanically-operated member. The control over the coil may be decoupled from the control over the mechanically-operated member. For example, the coil may be controlled by a control unit comprising an electromagnetic circuit that contains the coil. The mechanically-operated member may be controlled manually by a user.

The apparatus of the present invention may be employed in connecting one or more energy generation devices and/or energy storage devices to a load and/or to a grid. Said apparatus may provide a switching mechanism that facilitates disconnection of said device from another device or from the grid, when required, even if the relay is not functioning. For example, it may be necessary to connect the load to the energy storage device when there is not enough power provided by the energy generation device or wherein there is an outage in the distribution grid. The load may be disconnected from the energy storage device once the insufficient power situation is resolved. If the relay fails to perform the required action (connecting or disconnecting), the user may circumvent the malfunctioning relay by activating the bypass mechanism.

The switch may include a first terminal and a second terminal and a contact member configured to be in a first position and a second position. The contact member forms a connection between the first terminal and the second terminal when being either in the first position or in the second position. The switch may further include a control unit configured to facilitate a transition of the contact member and to retain the contact member at the first position or at the second position in the absence of an external force. The first position may be different from the second position, such that, e.g., when being in the first position, the contact member forms a connection between the first terminal and the second terminal and when being in the second position, the contact member does not form a connection between the first terminal and the second terminal. Alternatively, when being in the second position, the contact member may form a connection between the first terminal and the second terminal and when being in the first position, the contact member may not form a connection between the first terminal and the second terminal. Alternatively, when being in the first position, the contact member forms a connection between the first terminal and the second terminal and when being in the second position the contact member forms a connection between a third terminal and a fourth terminal.

The bypass mechanism may include at least a first moveable member having a first surface configured to contact an edge of the contact member at a first angle. The first surface may also be referred to as an engagement portion of the first moveable member, or as a first engagement portion. The edge may also be referred to as an engagement portion of the contact member, as an edge engagement portion, or as a mechanical engagement portion of the contact member. The mechanical engagement portion of the contact member may be the same as or different than the electrical engagement portion of the contact member. The first angle may be acute or obtuse. The first angle may be acute or obtuse relative to an axis that is perpendicular to the contact member. The axis may be perpendicular or orthogonal to a length of the contact member. The length of the contact member may extend away from the edge of the contact member along a longitudinal axis of the contact member. The axis may be orthogonal to the longitudinal axis of the contact member. The axis may be perpendicular or orthogonal to a longitudinal axis of the first movable member. In examples where the first movable member has a supporting layer, the axis may be parallel to the supporting layer of the first movable member. The supporting layer may extend along a latitudinal axis. The longitudinal axis of the first movable member may be orthogonal to the latitudinal axis of the supporting layer. In examples where the edge has a rounded surface, the axis may be parallel to a tangent of the rounded surface. In some examples the tangent may be at an extreme side of the rounded surface. For example, the tangent may be at a point at the end of the longitudinal axis of the contact member. The edge may be a portion of the surface of the contact member. The edge may be located at or near the end of the longitudinal axis of the contact member.

The bypass mechanism may further comprise a first actuator that is coupled to the first moveable member. The bypass of the switch by the bypass mechanism may be implemented by the first moveable member applying force to the edge of the contact member to facilitate its transition from the first position to the second position in response to force transmitted by the actuator. Said force may be, inter alia, manually applied by the user. The first moveable member therefore allows to either connect the first terminal and the second terminal or disconnect the first terminal and the second terminal (depending on the configuration of the switch).

The bypass mechanism may also be configured such that the first moveable member moves away from the edge of the contact member, when the force is no longer applied thereto. Said movement may be facilitated, e.g., by an elastic member.

The bypass mechanism may further comprise a second moveable member having a second surface configured to contact the edge of the contact member at a second angle. The second surface may also be referred to as an engagement portion of the second moveable member, or as a second engagement portion. The second angle may be acute or obtuse. For example, the second angle may be acute or obtuse relative to an axis that is perpendicular to the contact member (e.g., perpendicular to a length of the contact member). The second angle may be different from the first angle. The second moveable member may be configured to apply force to the edge of the contact member to facilitate its transition from the second position to the first position in response to the force applied to the second supporting layer.

Accordingly, the combination of the first moveable member and the second moveable member allows to both connect the first terminal and the second terminal and disconnect the first terminal and the second terminal. In other words, the combination of the first moveable member and the second moveable member provides a bidirectional bypass mechanism, allowing to fully control the switch operation irrespective of the operation of the control unit, including connecting the first terminal with the second terminal, when the contact member is retained at the first position or the second position by the control unit and disconnecting the first terminal from the second terminal, when the contact member is retained at the second position or the first position, respectively. For example, if the contact member forms the connection between the first terminal and the second terminal, when being in the first position, the bidirectional bypass mechanism allows to disconnect the first terminal from the second terminal, when the moveable member is in the first position. The bidirectional bypass mechanism further allows to connect the first terminal to the second terminal, when the contact member is in the second position. By providing the bidirectional bypass mechanism that does not rely on the operation of the control unit of the switch, the apparatus according to the principles of the present invention enables the user to manipulate any type of electric connection where said switch is installed.

Further aspects of the disclosure relate to an energy generation and/or storage system comprising the apparatus that comprises the switch and the bypass mechanism as outlined hereinabove, wherein the switch is configured to connect said system to at least one of a power grid and a load and wherein the bypass mechanism is configured to enable to disable a connection when the switch fails to perform said operation.

Further provided is a method of manually operating the switch of the apparatus as outlined hereinabove, comprising activating the first actuator, the second actuator, or both.

According to additional aspects and embodiments of the invention, there is provided a method of manually disconnecting an energy generation and/or storage system comprising the apparatus as outlined hereinabove, from at least one of a power grid and a load, the method comprising activating the first actuator. Furthermore, there is provided a method of manually connecting said energy generation and/or storage system to at least one of a power grid and a load, the method comprising activating the second actuator.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIGS. 1A-1D illustrate a switch device including a switch and a bypass mechanism, in accordance with some embodiments of the invention, wherein the bypass mechanism includes a first moveable member;

FIGS. 1E-1H illustrate an example of a switch device including a switch and a bypass mechanism, in accordance with some embodiments of the invention, wherein the bypass mechanism includes a second moveable member;

FIG. 2A illustrates a detailed view of a contact point between the first moveable member and a contact member of the switch device of FIGS. 1A-1D, in accordance with some embodiments of the invention;

FIG. 2B illustrates a detailed view of a contact point between the second moveable member and a contact member of the switch device of FIGS. 1E-1H, in accordance with some embodiments of the invention;

FIG. 2C illustrates a detailed view of a contact point between a first moveable member and a contact member having a different length than that of FIG. 2A, in accordance with some embodiments of the invention;

FIG. 2D illustrates a detailed view of a contact point between a second moveable member and a contact member having a different length than that of FIG. 2B, in accordance with some embodiments of the invention;

FIGS. 3A-3B illustrate a witch device including a switch and a bypass mechanism, in accordance with some embodiments of the invention, wherein the bypass mechanism includes a first moveable member and a second moveable member, wherein FIG. 3A shows the contact member of the switch being in the first position and FIG. 3B shows the contact member being in the second position;

FIG. 4A illustrates a bypass mechanism, in accordance with some embodiments of the invention, wherein the bypass mechanism includes a first supporting layer and a second supporting layer;

FIG. 4B illustrates an exploded view of the bypass mechanism of FIG. 4A, in accordance with some embodiments of the invention, wherein the bypass mechanism further includes a base;

FIG. 5A illustrates an exploded view of a switch device containing a switch that includes a plurality of switches and a bypass mechanism, in accordance with some embodiments of the invention, wherein the bypass mechanism includes a plurality of first moveable members and second moveable members;

FIGS. 5B-5C illustrate a cross-sectional view of the switch device of FIG. 5A;

FIG. 5D illustrates a detailed view of the switch device of FIG. 5A, wherein the switch is coupled to the bypass mechanism.

FIG. 6 illustrates a switch device in accordance with some embodiments of the invention, including an inner cover that partially encloses a switch and a bypass mechanism.

FIG. 7 schematically illustrates an energy generation and storage system comprising switch devices in accordance with some embodiments of the invention.

### DETAILED DESCRIPTION OF THE INVENTION

Unless defined otherwise, all technical and scientific terms used herein have the same meaning as commonly understood by one of ordinary skill in the art to which this disclosure belongs.

The present invention relates to an switch device comprising a switch comprising a control unit that operates said switch and a bypass mechanism, wherein the bypass mechanism is configured to manipulate the switch independently from the operation of the control unit. The bypass mechanism therefore allows to set and reset the switch even in instances where the control unit fails to perform this action. Operation of the bypass mechanism may be decoupled from the operation of the control unit. Advantageously, the bypass mechanism may be operated manually and does not require electrical power or complex circuity. This may become particularly important if the switch is in a form of latching relay, wherein the control unit comprises an electromagnetic circuit that is configured to set and reset the switch and which operation depends on electrical power supply and proper functioning of the electromagnetic circuit.

The switch of the switch device according to various aspects and embodiments of the present invention includes a contact member that is configured to be in a first position and a second position, wherein the switch connects between two terminals when being either in the first position or the second position. The bypass mechanism of the switch device according to various aspects and embodiments of the present invention includes at least one moveable member having a surface configured to contact an edge of the contact member. In some embodiments, the bypass mechanism includes a first moveable member. In some embodiments, the bypass mechanism includes a second moveable member. In some embodiments, the bypass mechanism includes a first moveable member and a second moveable member.

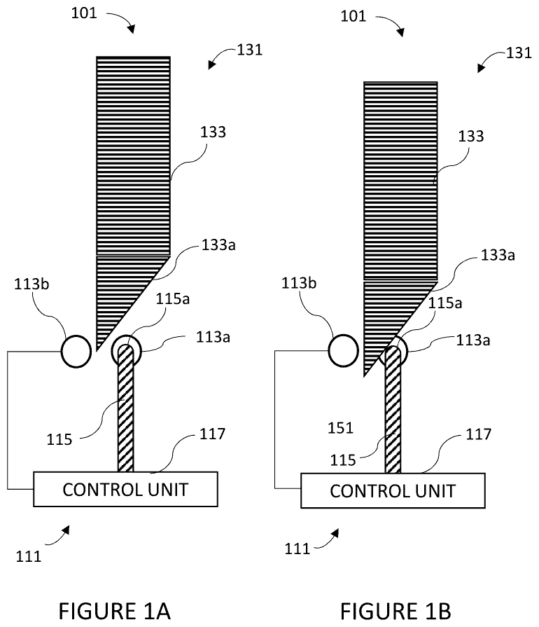

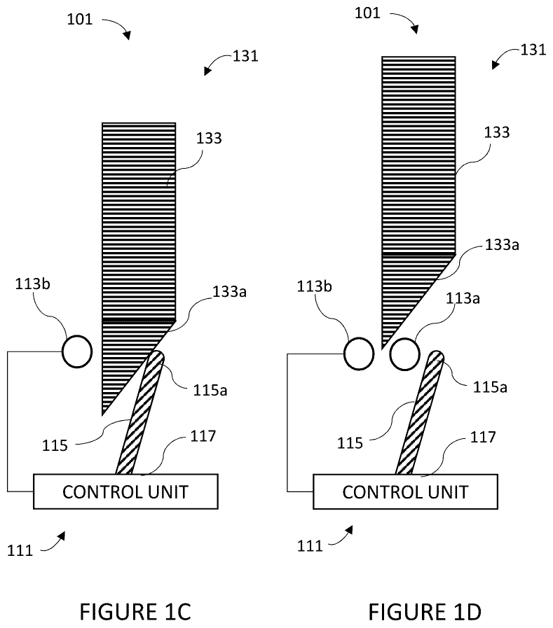

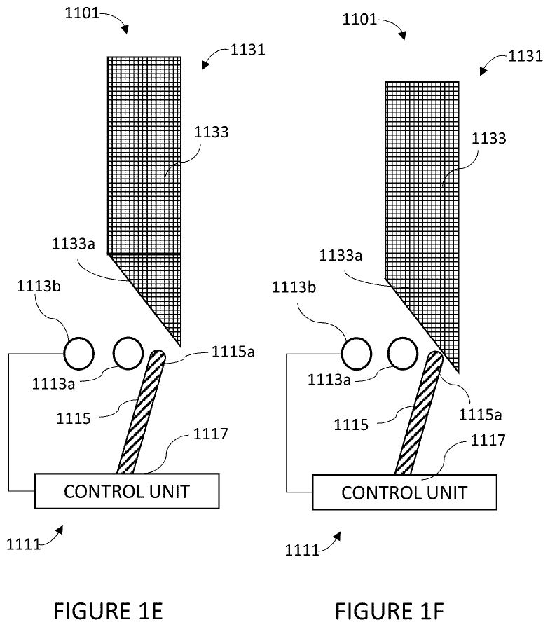

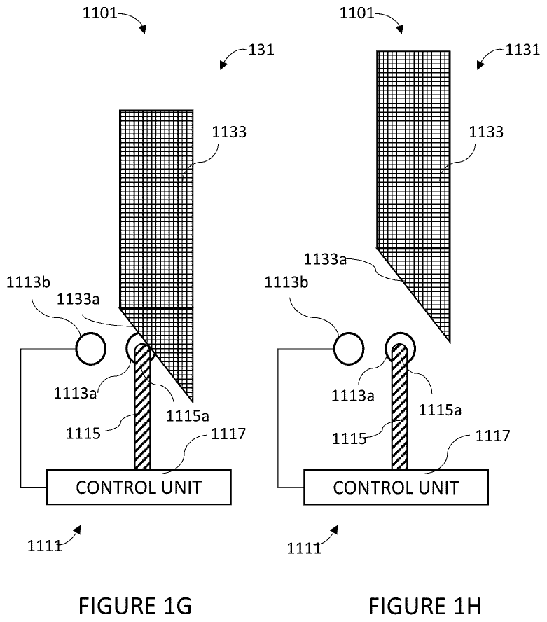

Reference is now made to FIGS. 1A-1D which schematically illustrate switch device 101 in accordance with some embodiments of the invention. Switch device 101 includes switch 111 and bypass mechanism 131. Switch 111 is an electromagnetic switch that is substantially composed of a support base and a set of electric components. Only major components of switch 111 that have some relevance to the present invention are schematically shown in the figures and described hereinbelow.

Switch 111 includes first terminal 113a, second terminal 113b, and contact member 115. Contact member 115 is configured to be at least in a first position and a second position. FIGS. 1A-1B show contact member 115 being in the first position and FIGS. 1C-1D show contact member 115 being in the second position. When contact member 115 is in the first position, it forms a connection between first terminal 113a and second terminal 113b. When contact member 115 is in the second position, there is no connection between first terminal 113a and second terminal 113b.

The terms “connection” and “connect”, as used herein, refer to electrical connection between the terminals. It is to be understood that while FIGS. 1A-1D illustrate switch device 101, wherein contact member 115 connects terminal 113a and terminal 113b when being in the first position, the switch device according to the principles of the present invention may be configured such that contact member 115 would connect terminal 113a with terminal 113b when being in the second position. It is further to be emphasized, that for illustrative purposes, in the first position, in which first terminal 113a is connected with second terminal 113b, contact member 115 is vertically oriented and in the second position, in which first terminal 113a is not connected with second terminal 113b, contact member 115 leans to the right. However, additional configurations of the switch device according to the principles of the present invention are also encompassed by the present disclosure, for example, wherein in the second position, in which the first terminal is not connected with the second terminal, the contact member leans to the left.

Contact member 115 has edge 115a. The terms “edge” and “contact member edge” are used herein interchangeably. Edge 115a may be a portion of the surface of the contact member 115. Edge 115a may be located at or near the end of the longitudinal axis of contact member 115. Edge 115a may be configured to contact first terminal 113a to establish connection between first terminal 113a and second terminal 113b when contact member 115 is in the first position (as shown in FIGS. 1A-1B). Alternatively, the switch device according to the principles of the present invention may be designed such that edge 115a contacts first terminal 113a to establish connection between first terminal 113a and second terminal 113b when contact member 115 is in the second position (not shown). Additionally, the switch device may be configured such that edge 115a contacts second terminal 113b to establish connection between first terminal 113a and second terminal 113b, when contact member 115 is either in the first position or in the second position. It is to be understood, however, that physical or direct contact between either one of first terminal 113a and second terminal 113b and contact member edge 115a is not essential in order to establish connection between the terminals when contact member 115 is either in the first position or the second position. For example, first terminal 113a may be electrically connected to edge 115a when contact member 115 is in the first position, thereby establishing connection between first terminal 113a and second terminal 113b. Further, contact member 115 when being in the first position, may establish electrical connection between first terminal 113a and second terminal 113b by means of a mechanical or electrical mechanism coupled to contact member 115 and being responsive to the movement of contact member 115. The portion of the contact member that establishes the electrical connection may be referred to as the electrical engagement portion of the contact member.

Switch 111 further includes control unit 117 configured to facilitate transition of contact member 115. For example, control unit 117 may be configured to facilitate transition of contact member 115 between the first position and the second position. Control unit 117 is further configured to retain contact member 115 at the first position or at the second position in the absence of an external force. It is to be understood that referring to the transition of the contact member 115 encompasses transition of edge 115a of contact member 115.

Control unit 117 may employ any mechanism known in the art to facilitate transition of contact member 115 and, optionally, to retain it in said position following transition. For example, control unit 117 may include an electromagnetic circuit that is configured to facilitate the transition of the contact member. The electromagnetic circuit may include an electromagnetic coil.

Contact member 115 may be made of any material that allows its transition between the first position and the second position, as effected by the control unit, and retainment thereof in said position in the absence of an external force. For example, the contact member may be made of magnetically conductive material, such as, but not limited to, iron or iron alloy, such that when a current pulse is supplied to the coil, attractive electromagnetic forces are generated between the contact member and the coil, positioned in proximity to the contact member, forcing the contact member to transition from the first position to the second position or vice versa. Applying a current pulse with an opposite polarity will create repulsive forces between the coil and the contact member, thereby inducing transition of the contact member in the opposite direction (i.e., from the second position back to the first position, or from the first position to the second position, respectively). In other words, the two operating positions of the contact member (i.e., the first position and the second position) may be controlled by energizing or de-energizing the coil.

The control unit may include a single coil. In certain such embodiments, polarity of the coil needs to be switched as the current pulse is delivered to the coil, in order to facilitate the transition of the edge of the contact member between its two positions. In other words, said single coil both sets and resets the switch, and depends on the input flow direction being reversed to do so.

The control unit may include two or more coils. For example, a control unit may include a set coil and reset coil, and a current pulse can be applied to either coil in order to facilitate the transition of the edge of the contact member between the first position and the second position.

Control unit 117 may further include a retaining component coupled to contact member 115 that is configured to retain contact member 115 stable at the first position or the second position in the absence of an external force applied to contact member 115. For example, the retaining component may include one or more magnetic components and mechanic components. The switch may be designed such that the contact member is retained in the first position by means of the retaining component, wherein the contact member does not require a retaining component to remain in the second position (or vice versa) due to the specific structure of the switch or its components. The switch may further include a first retaining component for retaining the contact member in the first position and a second retaining component for retaining the contact member in the second position, wherein both the first retaining component and the second retaining component may include either a magnetic retaining component or a mechanical retaining component.

In some embodiments, the control unit includes a magnetic retaining component, such as a permanent magnet. In certain such embodiments, the contact member is held in the first position or second position by electromagnetic force between the permanent magnet and the magnetic material of the contact member following de-energizing of the coil, until forced to change states (e.g., to move back in the opposite direction again via the application of a further pulse of current to the same coil or by energizing a different (reset) coil, whose magnetic field counteracts the field of the magnet. The permanent magnet may be selected or arranged with respect to the contact member to provide a magnetic field tending to bias the contact member from the first position or the second position but which does not apply a sufficient force to actually move the contact member to the second position or the first position, respectively. On the other hand, the magnetic field provided by the permanent magnet may be sufficient to hold the contact member in the position to which it has been transferred by the electromagnetic coil, until the next current pulse is applied by the control unit. It is to be understood that the strength of the magnetic field of the permanent magnet and the position thereof should not interfere with the operation of the bypass mechanism as explained hereinbelow. In other words, the bypass mechanism should be able to overcome the electromagnetic attraction between the contact member and the permanent magnet.

In some embodiments, the control unit includes a mechanic retaining component, such as, inter alia, a spring, mechanical lock, or gear. In certain such embodiments, the electromagnetic circuit facilitates the transition of the contact member between the first position and the second position and the mechanic retaining component retains the contact member in said first or second position following the transition. It should be emphasized that such mechanic retaining component should not interfere with the operation of the bypass mechanism as explained hereinbelow. For example, the mechanic retaining component should not prevent transition of the contact member between the first position and the second position when the first moveable member and/or the second moveable member of the bypass mechanism apply force to the edge of the contact member.

The contact member may have any shape as known in the art that allows connection between the first and the second terminal when being in the first position or in the second position. The contact member may have an elongated shape, such as a strip, a pin, a rod, a plate, etc. The shape of the contact member should further allow it to transition between the first position and the second position in response to a force applied by the moveable member, as explained in detain hereinbelow. The contact member and the one or more moveable members may have a depth. For example, the depth may extend along a plane or an axis that is orthogonal to the longitudinal axis of the contact member and the longitudinal axis of the one or more moveable members. For example, the contact member may be beveled and have a flat surface that is configured to engage the edge of contact member such that the contact between the two is made along the depth of the surface of the moveable member and the depth of the surface of the engagement portion of the contact member. The depth of the contact member may be such that a plurality of moveable members may be configured to engage the same contact member at different portions of the depth of the contact member. The contact member may have a plurality of engagement portions along the depth of the contact member, each engagement portion configured for engagement with one or more related surfaces of one or more of the plurality of moveable members.

The terms “elongated shape” or “length”, as used herein, refers in some embodiments to a shape having a dimension in a first direction that is longer than a dimension in a second direction different from the first direction. For example, an object having an elongated shape or a length may have a longitudinal axis that is longer than any other axis thereof.

The edge of the contact member may have any appropriate shape. The edge may be rounded, beveled, chamfered, sharp, etc. Without wishing to being bound by theory or mechanism of action, it is contemplated that the rounded shape decreases friction between the contact member and the at least one moveable member upon their contact. When referring to the angle formed between the edge of the contact member and the surface of the moveable member, the angle may be measured between the surface of the moveable member and a tangent to the edge, wherein said tangent is orthogonal to a longitudinal axis of the moveable member. For example, the tangent may be at a point at the end of the longitudinal axis of the contact member. The supporting layer may be perpendicular to the contact member (e.g., perpendicular to a length of the contact member) when the contact member is in at least one of its positions.

According to some embodiments, the switch is a latching relay. The latching relay may be a magnetic latching relay (i.e., containing an electromagnetic retaining component) or a mechanic latching relay (i.e., containing a mechanic retaining component). The switching action of the latching relay may be set up, for example, to complete or break a single circuit or as a method of switching power between two separate circuits.

It is to be understood that FIGS. 1A-1D contain a schematic representation of the control unit, such that its form and position with respect to the contact member and the first and the second terminals, should not be regarded as a structural feature of switch device 101. Furthermore, schematic connection between the first terminal and the second terminal that is effected through the control unit of the switch is shown for illustrative purposes only and any type of electrical circuit(s) may be employed to provide the electrical connection therebetween when the control member is either in the first or the second position.

Switch device 101 further includes bypass mechanism 131, as shown, for example, in FIGS. 1A-1D. Bypass mechanism 131 includes first moveable member 133 having first surface 133a. First moveable member 133 is configured to contact edge 115a of contact member 115 with its first surface 133a. First moveable member 133 is further configured to move towards contact member 115. First moveable member is further configured to move away from contact member 115. First moveable member is additionally configured to transition contact member 115 from the first position (as shown in FIGS. 1A-1B) to the second position (as shown in FIGS. 1C-1D). Transition of contact member 115 from the first position to the second position is enabled by the force applied by first moveable member 133 on contact member 115, and in particular, on edge 115a of contact member 115.

FIGS. 1A-1D show various positions of first moveable member 133 relatively to contact member 115. FIG. 1A shows first moveable member 133 in its rest position before it starts moving towards contact member 115. As explained hereinabove, the contact member may be retained in the first position either by a particular structure of the switch or by the control unit. It may be assumed for illustrative purposes that in FIG. 1A contact member 115 is retained in the first position by the structural configuration of switch 111 and/or contact member 115. FIG. 1B shows first moveable member 133 as it initially contacts contact member 115 that is still retained in the first position. The contact is between first surface 133a of first moveable member 133 and edge 115a of contact member 115. FIG. 1C shows first moveable member 133 that continues to contact edge 115a of contact member 115, while moving towards contact member 115. First moveable member 133 applies force onto contact member 115. It can be seen that edge 115a slides across first surface 133a of first moveable member 133 as contact member 115 moves away from first terminal 113a in response to the force applied by first moveable member 133. As a result, contact member 115 transitions from the first position to the second position, thereby breaking the electrical connection between first terminal 113a and second terminal 113b. It should be emphasized that said transition of contact member 115 from the first position to the second position is not effected by control unit 117. Instead, the transition is facilitated by first moveable member 133. FIG. 1D shows first moveable member 133 that moves away from edge 115a of contact member 115, returning to its rest position. In FIG. 1D first moveable member 133 does not contact edge 115a of contact member 115 and does not apply force thereto. Nevertheless, first moveable member 133 is retained in the second position by means of control unit 117, e.g., being electromagnetically attracted by a permanent magnet or physically held by a mechanical lock (not shown).

The bypass mechanism having retraction feature (i.e., the moveable member that can move away from the contact member following its transition from the first position to the second position or vice versa, that is facilitated by the bypass mechanism), may be particularly useful, as it does not interfere with the functioning of the switch. For example, if there is a temporary switch failure and using the bypass mechanism is required in order to set the switch, the retraction feature allows to reset the switch when it goes back to normal functioning, by employing the control unit of the switch instead of the bypass mechanism. Since the moveable member moves away from the contact member as soon as it transitions from the fist position to the second position or vice versa, the moveable member will not physically prevent the contact member from going back to the second position or the first position, respectively, when activated by the control unit.

Reference is now made to FIGS. 1E-1H which schematically illustrate switch device 1101 in accordance with some embodiments of the invention. Switch device 1101 includes switch 1111 and bypass mechanism 1131. Switch 1111 is an electromagnetic switch that is substantially composed of a support base and a set of electric components (not shown). Only major components of switch 1111 that have some relevance to the present invention are schematically shown in the figures and described hereinbelow.

Switch 1111 may be identical to switch 111, as described in relation to FIGS. 1A-1D.

Switch 1111 includes first terminal 1113a, second terminal 1113b, and contact member 1115. Contact member 1115 is configured to be at least in a first position and a second position. FIGS. 1E-1F show contact member 1115 being in the second position and FIGS. 1G-1H show contact member 1115 being in the first position. When contact member 1115 is in the first position, it forms a connection between first terminal 1113a and second terminal 1113b. When contact member 1115 is in the second position, there is no connection between first terminal 1113a and second terminal 1113b.

It is further to be understood that while FIGS. 1G-1H illustrate switch device 1101, wherein contact member 1115 connects terminal 1113a and terminal 1113b when being in the first position, the switch device according to the principles of the present invention may be configured such that contact member 1115 would connect terminal 1113a with terminal 1113b when being in the second position.

Contact member 1115 has edge 1115a. Edge 1115a may be configured to contact first terminal 1113a to establish connection between first terminal 1113a and second terminal 113b when contact member 1115 is in the first position (as shown in FIGS. 1G-1H).

Switch 1111 further includes control unit 1117 configured to facilitate transition of contact member 1115. For example, control unit 1117 may be configured to facilitate transition of contact member 1115 between the first position and the second position. Control unit 1117 is further configured to retain contact member 1115 at the first position or at the second position in the absence of an external force. It is to be understood that referring to the transition of the contact member 1115 encompasses transition of edge 1115a of contact member 1115.

Control unit 1117 may be identical to control unit 117, as described in relation to FIGS. 1A-1D.

It is to be understood that FIGS. 1E-1H contain a schematic representation of the control unit, such that its form and position with respect to the control member and the first and the second terminals, should not be regarded as a structural feature of switch device 1101. Furthermore, electrical connection between the first terminal and the second terminal that is effected through the control unit of the switch is made for illustrative purposes only and any type of electrical circuit(s) may be employed to provide the electrical connection therebetween when the control member is either in the first or the second position.

Switch device 1101 further includes bypass mechanism 1131, as shown, for example, in FIGS. 1E-1H. Bypass mechanism 1131 includes second moveable member 1133 having second surface 1133a. Second moveable member is configured to contact edge 1115a of contact member 1115 with its second surface 1133a. Second moveable member is further configured to move towards contact member 1115. Second moveable member is further configured to move away from contact member 1115. Second moveable member is additionally configured to transition contact member 1115 from the second position in which it is retained by control unit 1117 (as shown in FIGS. 1E-1F) to the first position (as shown in FIGS. 1G-1H). Transition of contact member 1115 from the second position to the first position is enabled by the force applied by second moveable member 1133 on contact member 1115, and in particular, on edge 1115a of contact member 1115.

FIGS. 1E-1H show various positions of second moveable member 1133 relatively to contact member 1115. FIG. 1E shows second moveable member 1133 in its rest position, before it moves towards contact member 1115. As explained hereinabove, the contact member may be retained in the first position either by a particular structure of the switch or by the control unit. It may be assumed for illustrative purposes that in FIG. 1E contact member 1115 is retained in the second position by control unit 1117, e.g., being electromagnetically attracted by a permanent magnet or physically held by a mechanical lock (not shown). FIG. 1F shows second moveable member 1133 as it initially contacts contact member 1115 that is still retained in the second position. The contact is between second surface 1133a of moveable member 1133 and edge 1115a of contact member 1115. FIG. 1G shows second moveable member 1133 that continues to contact edge 1115a of contact member 1115, while moving towards contact member 1115. Second moveable member 1133 applies force onto contact member 1115. It can be seen that edge 1115a slides across second surface 1133a of moveable member 1133 as contact member 1115 moves towards first terminal 1113a in response to the force applied by second moveable member 1133. As a result, contact member 1115 transitions from the second position to the first position, thereby establishing the electrical connection between first terminal 1113a and second terminal 1113b. It should be emphasized that said transition of contact member 1115 from the second position to the first position is not effected by control unit 1117. Instead, the transition is facilitated by second moveable member 1133. FIG. 1H shows second moveable member 1133 that moves away from edge 1115a of contact member 1115, returning to its rest position. In FIG. 1H moveable member 1115 does not contact edge 1115a of contact member 1115 and does not apply force thereto. Nevertheless, second moveable member 1133 is retained in the first position by the structural configuration of switch 1111 and/or contact member 1115. The portion of the contact member that establishes the electrical connection may be referred to as the electrical engagement portion of the contact member.

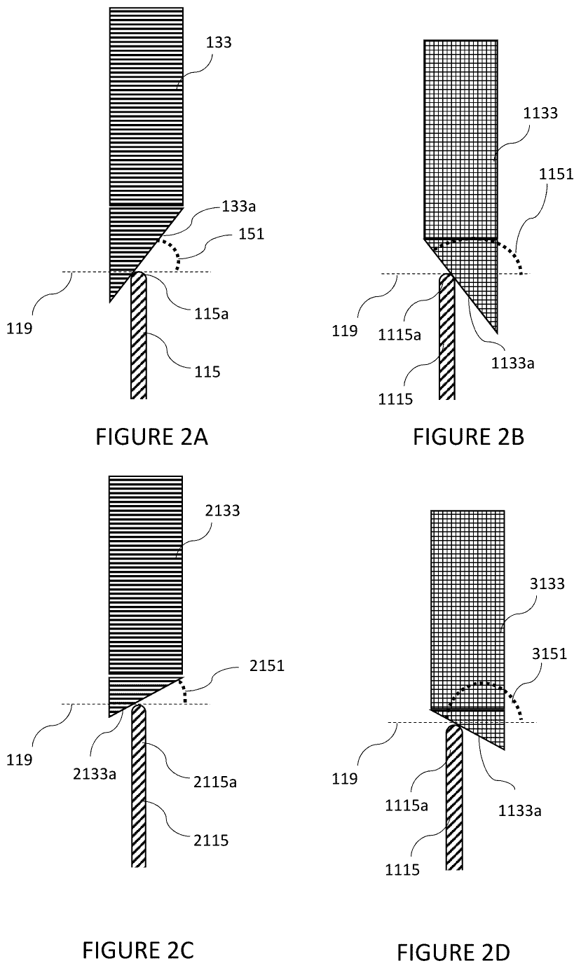

Reference is now made to FIG. 2A which schematically illustrates contact member 115 and first moveable member 133 of switch device 101, in accordance with some embodiments of the invention. FIG. 2A is a detailed view of a portion of FIG. 1B, which shows first moveable member 133 as it initially contacts contact member 115 that is retained in the first position. When first surface 133a of first moveable member 133 contacts edge 115a of contact member 115, there is first angle 151 between first surface 133a of first moveable member 133 and edge 115a of contact member 115.

The term “first angle”, as used herein, refers to an angle formed between the edge of the contact member and the first surface of the first moveable member, upon contact of the first moveable member with the contact member, wherein the contact member is parallel to the longitudinal axis of the first moveable member, as shown in FIG. 2A. For example, in FIGS. 1A-1D, the term “first angle” refers to an angle formed when the contact member is still in the first position and it contacts the moveable member (FIG. 1B).

Without wishing to being bound by mechanism of action, it is contemplated that the first angle should be acute or obtuse in order to enable transition of the contact member between the first position and the second position in response to the force applied by the first moveable member onto the contact member. It is to be understood that the terms “acute angle” and “obtuse angle” may refer to supplementary angles, depending on the side of the moveable member and/or the contact member, where the angle is measured. In some examples, the angle may be measured relative to an axis that is perpendicular to the contact member (e.g., perpendicular to a length of the contact member).

Without further wishing to being bound by mechanism of action, it is contemplated that in order to transfer contact member 115 from the first position to the second position, as shown in FIGS. 1A-1D, first angle 151, as indicated in FIG. 2A, should be acute. Upon such contact that forms an acute angle, edge 115a of contact member 115 will move right (away from first terminal 113a). For example, the first angle 151 may be measured relative to an axis 119 that is perpendicular to the contact member 115 (e.g., orthogonal to a length of the contact member). Axis 119 may be orthogonal to the longitudinal axis of the contact member 115, and orthogonal to the axis of the depth of the contact member 115. Axis 119 may extend along a width of the contact member 115. Axis 119 may also be referred to as the latitudinal axis of the contact member 115.

Reference is now made to FIG. 2B which schematically illustrates contact member 1115 and second moveable member 1133 of switch device 1101, in accordance with some embodiments of the invention. FIG. 2B is a detailed view of a portion of FIG. 1G, which shows second moveable member 1133 that continues to contact edge 1115a of contact member 1115 after contact member 1115 transitions from the second position to the first position under the force applied by second moveable member 1133 on contact member 1115. When surface 1113a of second moveable member 1133 contacts edge 1115a of contact member 1133, there is second angle 1151 between second surface 1133a of second moveable member 1133 and edge 1115a of contact member 1115.

The term “second angle”, as used herein, refers to an angle formed between the edge of the contact member and the second surface of the second moveable member, upon contact of the second moveable member with the contact member, wherein the contact member is parallel to the longitudinal axis of the second moveable member, as shown in FIG. 2B. For example, in FIGS. 1E-1H, the term “angle” refers to an angle formed when the contact member is in the first position after it has been transferred from the first position and it still contacts the moveable member (FIG. 1G).

Without wishing to being bound by mechanism of action, it is contemplated that the second angle should be acute or obtuse in order to enable transition of the contact member between the second position and the first position in response to the force applied by the second moveable member onto the contact member. In some examples, the second angle may be measured relative to an axis that is perpendicular to the contact member (e.g., perpendicular to a length of the contact member).

Without further wishing to being bound by mechanism of action, it is contemplated that in order to transfer contact member 1115 from the second position to the first position, as shown in FIGS. 1E-1H, second angle 1151, as indicated in FIG. 2B, should be obtuse. Upon such contact that forms an obtuse angle, edge 1115a of contact member 1115 will move left (towards second terminal 1113b).

When having more than one moveable member and referring to more than one angle formed between each moveable member and the contact member, i.e., the first angle and the second angle, the angles may be measured relative to a tangent to the edge of the contact member. The tangent may be at a point at the end of the longitudinal axis of the contact member. The tangent may be perpendicular or orthogonal to the longitudinal axis of the contact member. For example, the first angle may be measured between the first surface of the first moveable member and the tangent to the edge of the contact member. and the second angle may be measured between the second surface of the second moveable member and the tangent to the edge of the contact member. The tangent may be substantially the same as or similar to axis 119 shown in FIGS. 2A-2D.

The first moveable member may be combined with the second moveable member in a single bypass mechanism in order to allow bidirectional bypass of the switch, i.e., setting and resetting the switch by connecting and disconnecting the first terminal and the second terminal without activating the control unit. While the first moveable member enables transition of the contact member from the first position to the second position, the second moveable member enables transition of the same contact member from the second position to the first position. Without wishing to being bound by theory or mechanism of action, it is contemplated that in order to allow such bidirectional bypassing, the first angle should be different from the second angle. For example, when combining first moveable member 133 as shown in FIG. 2A and second moveable member 1133, as shown in FIG. 2B, in a single bypass mechanism, first angle 151 may be acute and second angle 1151 may be obtuse. In such case, contact member 115 will shift from the first position to the second position in response to the force applied by first moveable member 133 on contact member 115 (i.e., edge 115a of contact member 115 will move to the right away from the first terminal) and contact member 115 will shift from the second position to the first position in response to the force applied by second moveable member 1133 on contact member 115 (i.e., edge 115a of contact member 115 will move to the left towards the first terminal). In some examples, the angle may be measured relative to an axis that is perpendicular to the contact member (e.g., perpendicular to a length of the contact member).

Each one of the first angle and the second angle, individually, may range between about 5° to about 85° or between about 95° to about 175°. For example, the first angle may range from about 10° to about 80°. In some embodiments, the first angle ranges from about 15° to about 60°. In further embodiments, the first angle ranges from about 20° to about 40°. In certain embodiments, the first angle is about 30°. In some embodiments, the first angle ranges from about 100° to about 170°. In some embodiments, the first angle ranges from about 120° to about 165°. In further embodiments, the first angle ranges from about 140° to about 160°. In certain embodiments, the first angle is about 150°.

The second angle may range from about 100° to about 170°. In some embodiments, the second angle ranges from about 120° to about 165°. In further embodiments, the second angle ranges from about 140° to about 160°. In certain embodiments, the second angle is about 150°. In some embodiments, the second angle ranges from about 10° to about 80°. In some embodiments, the second angle ranges from about 15° to about 60°. In further embodiments, the second angle ranges from about 20° to about 40°. In certain embodiments, the second angle is about 30°.

In some embodiments, the first angle ranges from about 20° to about 40° and the second angle ranges from about 140° to about 160°. In some embodiments, the first angle and the second angle are supplementary angles.

The first angle and the second angle may be selected in accordance with the length of the contact member and/or a distance the edge of the contact member must travel to shift between the first position and the second position. The value of the first angle and of the second angle may affect the mechanical stress experienced by the contact member, thereby affecting the movement of the contact member, e.g., the distance that the edge of the contact member may travel. For example, when the same amount of force is applied to first moveable members with different first angles—the stress experienced by the contact member upon the contact with each first moveable member may be different, such that the movement of the edge of the contact member may be controlled by choosing the slope of the first surface without the need to adjust the applied force and/or the length of the first moveable member. The same bypass mechanism may include a plurality of first moveable members with different values of the first angle and/or a plurality of second moveable members with different values of the second angle to accommodate switches with different lengths of the contact member.

Reference is now made to FIG. 2C which schematically illustrates contact member 2115 and first moveable member 2133, in accordance with some embodiments of the invention. It can be seen that contact member 2115 is longer than contact member 115 of FIG. 2A and that first angle 2151 formed between first surface 2133a and contact member 2115 is smaller than first angle 151 of FIG. 2A. First moveable member 2133 applies higher stress on contact member 2115 than the stress applied by first moveable member 133 on contact member 115, thereby enabling larger travel distance of contact member 2115 as compared to contact member 115. This way, different slopes of first surfaces 2133a and 133a are used to fit switches with different contact member lengths and different travel distances between the first position and the second position. In a similar manner a contact member may be shorter than contact member 115 of FIG. 2A and that first angle formed between first surface and contact member may be larger than first angle 151 of FIG. 2A. First moveable member may apply less stress on contact member than the stress applied by first moveable member 133 on contact member 115, thereby enabling shorter travel distance of contact member as compared to contact member 115.

Reference is now made to FIG. 2D which schematically illustrates contact member 3115 and second moveable member 3133, in accordance with some embodiments of the invention. It can be seen that contact member 3115 is longer than contact member 1115 of FIG. 2B and that second angle 3151 formed between first surface 3133a and contact member 3115 is larger than second angle 1151 of FIG. 2A. Second moveable member 3133 applies higher stress on contact member 3115 than the stress applied by second moveable member 1133 on contact member 1115, thereby enabling larger travel distance of contact member 3115 as compared to contact member 1115. This way, different slopes of second surfaces 3133a and 1133a are used to fit switches with different contact member lengths and different travel distances between the first position and the second position. In a similar manner a contact member may be shorter than contact member 1115 of FIG. 2B and that second angle formed between first surface and contact member may be smaller than second angle 1151 of FIG. 2A. Second moveable member may apply less stress on contact member than the stress applied by second moveable member 1133 on contact member 1115, thereby enabling shorter travel distance of contact member as compared to contact member 1115.

As explained hereinabove, the acute or obtuse angle formed between the surface of the moveable member and the contact member enables the moveable member to release the contact member from the first position or the second position and to transfer it to the second position or the first position, respectively. In some examples, the angle may be measured relative to an axis that is perpendicular to the contact member (e.g., perpendicular to a length of the contact member). For example, the angle may be measured between the surface of the moveable member and the axis relative to the contact member. Another feature of the moveable member that may affect the efficiency of the bypass mechanism is a length of the first surface of the moveable member relatively to the length of the edge of the contact member. The length of the first surface may be greater than the length of the edge of the contact member. For example, a ratio between the length of the first surface and the length of the edge of the contact member may be at least about 1.5:1. In some embodiments, the ratio between the length of the first surface and the length of the edge of the contact member is at least about 2:1, at least about 3:1, or at least about 5:1. A ratio between the length of the second surface and the length of the edge of the contact member may also be at least about 1.5:1. In some embodiments, the ratio between the length of the second surface and the length of the edge of the contact member is at least about 2:1, at least about 3:1, or at least about 5:1. The length of the first surface may also affect the distance that the edge of the contact member may travel under the force applied thereon by the moveable member.

The length of the longitudinal axis of the first moveable member and the second moveable member may also be adjusted to control the distance that the edge of the contact member may travel under the force applied thereon by the moveable member.

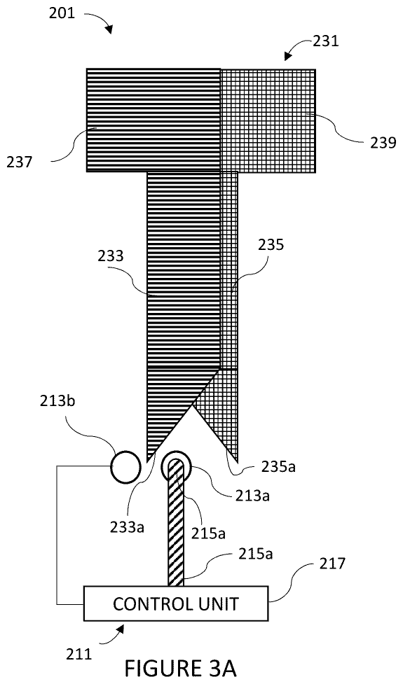

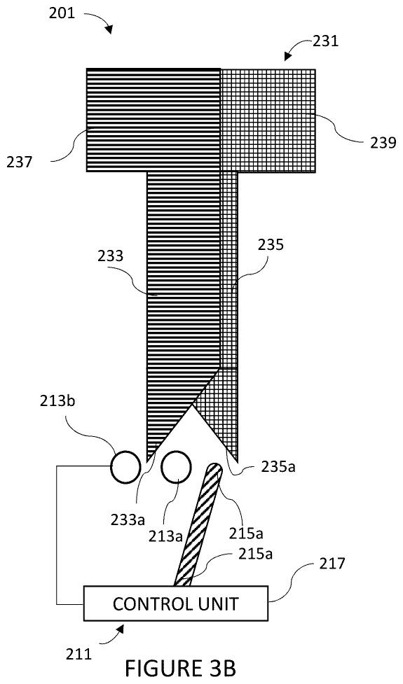

Reference is now made to FIGS. 3A-3B, which schematically show switch device 201 including switch 211 and bypass mechanism 231, according to some embodiments of the invention. Switch 211 includes first terminal 213a, second terminal 213b, contact member 215, and control unit 217. Contact member 215 is configured to be at least in the first position, as shown in FIG. 3A and a second position, as shown in FIG. 3B. When contact member 215 is in the first position, it forms a connection between first terminal 213a and second terminal 213b. When contact member 215 is in the second position, there is no connection between first terminal 213a and second terminal 213b.

Bypass mechanism 231 includes first moveable member 233 having first surface 233a and second moveable member 235 having second surface 235a. First moveable member 233 is configured to contact edge 215a of contact member 215 with its first surface 233a. First moveable member 233 is further configured to move towards contact member 215 to transition contact member 215 from the first position (as shown in FIG. 3A) to the second position (as shown in FIG. 3B). Transition of contact member 215 from the first position to the second position is enabled by the force applied by first moveable member 233 on contact member 215, and in particular, on edge 215a of moveable member 215. First moveable member 233 is further configured to move away from contact member 215 after contact member shifts from the first position to the second position. Contact member 215 is configured to remain in the second position, being retained therein by control unit 217, as described in detail hereinabove, in the absence of external force, e.g., electromagnetic force applied by control unit 217 or mechanical force applied by second moveable member 235 of bypass mechanism 231.

Second moveable member 235 is configured to contact edge 215a of contact member 215 with its second surface 235a. Second moveable member 235 is further configured to move towards contact member 215 to transition contact member 215 from the second position (as shown in FIG. 3B) to the first position (as shown in FIG. 3A). Transition of contact member 215 from the second position to the first position is enabled by the force applied by second moveable member 235 on contact member 215, and in particular, on edge 215a of moveable member 215. Second moveable member 235 is further configured to move away from contact member 215 after contact member shifts from the second position to the first position. Contact member 215 is configured to remain in the first position, being retained therein by the structural configuration of switch 211 and/or contact member 215, as described in detail hereinabove, in the absence of external force, e.g., electromagnetic force applied by control unit 217 or mechanical force applied by first moveable member 233 of bypass mechanism 231.

It can be seen from FIGS. 3A-3B that first surface 233a of first moveable member 233 contacts edge 215a of contact member 215 at a different angle than that formed between edge 215a and second surface 235a of second moveable member 235. As explained hereinabove, the first angle should may be different from the second angle. The first angle being different from the second angle may help enable transition of contact member 215 from the first position to the second position and from the second position to the first position by a single bypass mechanism 231.

The bypass mechanism may further include a supporting layer, wherein the moveable member may be coupled to the supporting layer. The bypass mechanism may include a first supporting layer that is coupled to the first moveable member. The bypass mechanism may include a second supporting layer that is coupled to the second moveable member. In some embodiments, the bypass mechanism includes a first supporting layer that is coupled to the first moveable member and a second supporting layer that is coupled to the second moveable member.

Bypass mechanism 231 further includes first supporting layer 237. First moveable member 233 is coupled to first supporting layer 237. First moveable member 233 and first supporting layer 237 may be made as a single element or two different elements connected by any suitable means as known in the art, such as, but not limited to an adhesive or a spring. First moveable member 233 has an elongated shape, such that its longitudinal axis extends between first supporting layer 237 and first surface 233a. First moveable member 233 may be arranged such that its longitudinal axis is parallel to contact member 215, when it is in its first position and first supporting layer 237 is orthogonal to contact member 215.

Bypass mechanism 231 further includes second supporting layer 239. Second moveable member 235 is coupled to second supporting layer 239. Second moveable member 235 and second supporting layer 239 may also be a single element or two different elements connected by any suitable means. Second moveable member 235 has an elongated shape, such that its longitudinal axis extends between second supporting layer 239 and second surface 235a. Second moveable member 235 may be arranged such that its longitudinal axis is parallel to contact member 215, when it is in its first position and second supporting layer 239 is orthogonal to contact member 215.

In order to provide the bypass mechanism structure in which the moveable member is configured to contact the edge of the contact member at an acute or obtuse angle, the moveable member may have a contact surface that is not parallel to the first supporting layer and/or is not orthogonal to the longitudinal axis of the moveable member. When the longitudinal axis of the moveable member is parallel to the longitudinal axis of the contact member, the first surface of the moveable member might not be parallel to the edge of the contact member, and an acute or obtuse angle may be formed therebetween. For example, as can be seen from FIGS. 3A-3B, first surface 233a forms an acute or obtuse angle with first supporting layer 237 and second surface 235a forms an acute or obtuse angle with second supporting layer 239. In some examples, the angle may be measured relative to a supporting layer. The supporting layer may be perpendicular to the contact member (e.g., perpendicular to a length of the contact member). The supporting layer may have a latitudinal axis that is perpendicular to a longitudinal axis of the contact member. The latitudinal axis of the supporting layer may be perpendicular or orthogonal to a longitudinal axis of the moveable member. In some examples, the angle may be measured relative to an axis that is perpendicular to the contact member (e.g., perpendicular to a length of the contact member). For example, the angle may be measured between the first surface of the moveable member and an axis relative to the edge of the contact member.

As mentioned hereinabove, first moveable member 233 is configured to move towards edge 215a of contact member 215. Said movement may be induced by a force applied to first supporting layer 237. Second moveable member 235 is also configured to move towards edge 215a of contact member 215 in response to a force applied to second supporting layer 239. While first supporting layer 237 may be disposed adjacently to second supporting layer 239, they should be able to move independently, to allow individual motion of first moveable member 233 and second moveable member 235.

In some embodiments, the first supporting layer is disposed adjacently to the second supporting layer when no force is applied to the first supporting layer and to the second supporting layer. In some embodiments, the first moveable member is disposed adjacently to the second moveable member when no force is applied to the first supporting layer and to the second supporting layer.

When force is applied to the supporting layer, the supporting layer may move together with the moveable member towards the contact member. The supporting layer may shift between its rest position, wherein there is no force applied to the supporting layer and there is no contact between the moveable member and the contact member, to a position where force is applied to the supporting layer and the moveable member cannot move any further towards the contact member. Alternatively, the supporting layer may remain in place, while transferring said force to the moveable member and inducing its motion towards the contact member.

When force is applied to first supporting layer 237 and first moveable member 233 moves towards contact member 215, it applies force on edge 215a of contact member 215 to facilitate its transition from the first position to the second position. First moveable member 233 may be positioned on first supporting layer 237 relatively to edge 215a of contact member 215 such that when the force is applied to first supporting layer 237, upon the contact between first moveable member 233 and edge 215a, edge 215a slides along first surface 233a of first moveable member 233 away from first terminal 213a, thereby shifting from the first position to the second position.

When force is applied to second supporting layer 239 and second moveable member 235 moves towards contact member 215, it applies force on edge 215a of contact member 215 to facilitate its transition from the second position to the first position. Second moveable member 235 may be positioned on second supporting layer 239 relatively to edge 215a of contact member 215 such that when the force is applied to second supporting layer 239, upon the contact between second moveable member 235 and edge 215a, edge 215a slides along second surface 235a of second moveable member 235 towards first terminal 213a, thereby shifting from the second position to the first position.

The bypass mechanism may further include an actuator that is coupled to the supporting layer. The actuator may be coupled to the moveable member through the supporting layer. The bypass mechanism may include a first actuator coupled to the first supporting layer. The bypass mechanism may include a second actuator coupled to the second supporting layer. In some embodiments, the bypass mechanism includes a first actuator coupled to the first supporting layer and a second actuator coupled to the second supporting layer.

In some examples, the first position may be connection to one terminal and the second position may be connection to another terminal. In some examples, the first position may be connection to no terminal, and the second position may be connection to a terminal.

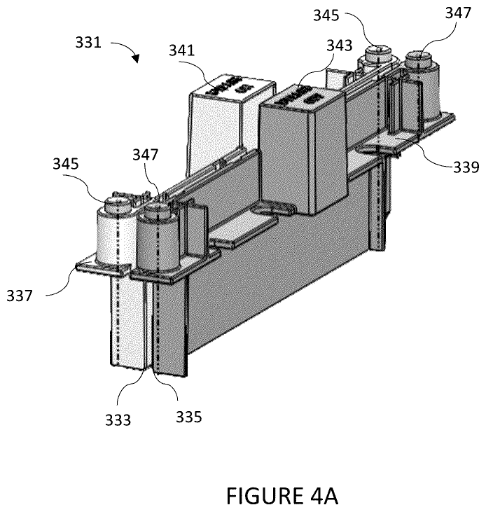

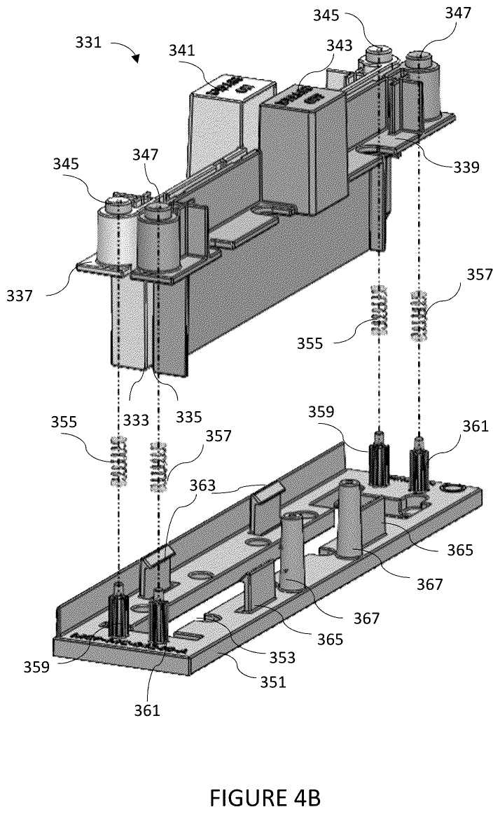

Reference is now made to FIGS. 4A-4B that schematically shows bypass mechanism 331, according to some embodiments of the invention. Bypass mechanism 331 may be coupled to the switch as described in the various embodiments hereinabove. Bypass mechanism 331 includes first moveable member 333 and first supporting layer 337, wherein first moveable member 333 is coupled to first supporting layer 337. First moveable member 333 has first surface that is configured to contact the contact member of the switch to facilitate its transition from the first position to the second position. Bypass mechanism 331 further includes second moveable member 335 and second supporting layer 339, wherein second moveable member 335 is coupled to second supporting layer 339. Second moveable member 335 has second surface that is configured to contact the contact member of the switch to facilitate its transition from the second position to the first position.

Bypass mechanism 331 further includes first actuator 341 coupled to first supporting layer 337. First actuator 341 is further coupled to first moveable member 333 through first supporting layer 337. First actuator 341 may be configured to apply force onto first supporting layer 337 in response to a signal received from a user. First actuator 341 may be further configured to facilitate the movement of first moveable member 333 in response to said signal.

Bypass mechanism 331 further includes second actuator 343 coupled to second supporting layer 339. Second actuator 343 is further coupled to second moveable member 335 through second supporting layer 339. Second actuator 343 may be configured to apply force onto second supporting layer 339 in response to a signal received from a user. Second actuator 343 may be further configured to facilitate the movement of second moveable member 335 in response to said signal.

The actuator may be further configured to enable the movement of the moveable member away from the contact member following its contact with the contact member. The movement of the moveable member away from the contact member may start once the signal from the user that facilitates the movement of the moveable member towards the contact member has stopped. For example, if the actuator comprises a push button, once the user stops pressing it, the moveable member may move away from the contact member and return to its rest position. The actuator may be further configured to facilitate the movement of the moveable member towards the contact member until it contacts the contact member and transfers from the first position to the second position or vice versa, even after the signal from the user has stopped. In some examples, the movement of the moveable member away from the contact member may start upon receipt of a second signal.

The actuator and the supporting layer may be a single clement or may be two different elements connected by any suitable means as known in the art. Said means may further be configured to translate the signal received from the user to the force applied onto the supporting layer. In some embodiments, the actuator, the supporting layer, and the moveable member are a monolithic structure.

Non-limiting examples of suitable actuators include a push button, pressure sensor, touch pad, electric actuator, hydraulic actuator, pneumatic actuator, and any combination thereof. In some examples the actuator may be configured to work based on a received wireless signal or received wired signal. For example the signal may be received from a transmitter that is located at a different location than the actuator.

For example, first actuator 341 and second actuator 343 may include a push button, as shown in FIG. 4A. In certain such embodiments, the signal received from the user is the force applied on the push button by the user. First actuator 341 comprising the push button is an integral part of first supporting layer 337 and second actuator 343 comprising the push button is an integral part of second supporting layer 339. The push button may be configured such that application of the force to the push button displaces the respective supporting layer from its rest position and facilitates movement of the respective moveable member towards the contact member. The push button may move together with the supporting layer and the moveable member. When the user ceases to activate the push button (i.e., stops to apply force to it), the respective supporting layer may return to its rest position and the respective moveable member moves away from the contact member. The push button may be further configured to apply force on the moveable member that is sufficient for contacting the contact member and transferring it from the first position to the second position or vice versa regardless of the amount of force applied to the push button.

The bypass mechanism may further include a base that is complimentary to the first supporting layer and the first moveable member. The base may be further complimentary to the second supporting layer and the second moveable member.

FIG. 4B further shows base 351 that is a part of bypass mechanism 331 and that is complimentary to first moveable member 333, second moveable member 335, first supporting layer 337, and second supporting layer 339. Base 351 has opening 353 that corresponds to the cross section of first moveable member 333 and second moveable member 335, such that first moveable member 333 and second moveable member 335 are configured to pass through opening 353.

The supporting layer and the base may be coupled via a first mechanism that is configured to retain a predefined distance between the supporting layer and the base when no force is applied to the supporting layer. The mechanism may further be configured to move the moveable member away from the contact member when the force is no longer applied to the supporting layer. Said mechanism may include at least one of an elastically compressible member, an inflatable member, a hydraulic actuator, a pneumatic actuator and a magnetic actuator. In some embodiments, the mechanism includes an elastically compressible member that is a spring.

For example, FIG. 4B shows that bypass mechanism includes base 351 that is coupled to first supporting layer 337 via a first mechanism that is configured to retain a first predefined distance between first supporting layer 337 and base 351 when the force is not applied to the first supporting layer 337 (i.e., when first supporting layer is in its rest position) and to move first moveable member 333 away from the contact member (not shown) when the force is no longer applied to first supporting layer 337. The first mechanism includes two first springs 355 that are disposed between first supporting layer 337 and base 351. Base 351 includes two first pins 359 which position relatively to the longitudinal axis of base 351 corresponds to the position of first springs 355. Each first pin 359 is configured to contact its corresponding first spring 355 at one end of the spring. First supporting layer 337 includes two first receptacles 345 which position relatively to the longitudinal axis of first supporting layer 337 corresponds to the position of first springs 355 and first pins 359. Each first receptacle 345 is configured to contact its corresponding first spring 355 at the other end of the spring. At least a first portion of first pin 359 is configured to be inserted into its corresponding first receptacle 345. At least a second portion of first pin 359 is configured to be inserted into its corresponding first receptacle 345 when the force is applied to first supporting layer 337. The second portion may be greater than the first portion. In some embodiments, first pin 359 is configured to be fully inserted into its corresponding first receptacle 345 when the force is applied to first supporting layer 337. In some examples no portion of first pin 359 is configured to be inserted into its corresponding first receptacle 345 when no force is applied to first supporting layer 337, and at least a portion of first pin 359 may be configured to be inserted into its corresponding first receptacle 345 when force is applied to first supporting layer 337.

For example, when no force is applied to first supporting layer 337, first spring 355 is in its first state, the first portion of first pin 359 may be inserted into first receptacle 345, and first supporting layer 337 is retained in its rest position by the first mechanism. In the rest position, first supporting layer is located at the first predefined distance from base 351. When force is applied to first supporting layer (e.g., in response to the signal transmitted by first actuator 341, such as pressing push button by the user), first supporting layer 337 moves towards base 351, applying force to first spring 355 leading its compression. The second portion of first pin 359 may be inserted into first receptacle 345 once first spring 355 is compressed into its second state, said second portion may be greater than the first portion. In said position, first moveable member 333 may contact the contact member (not shown), and transfer it from the first position to the second position, or vice versa. When force is no longer applied to first supporting layer 337 (e.g., when the user stops pressing push button) and, consequently, on first spring 355, first spring 355 gets relaxed, initiating movement of first supporting layer 337 away from base 351 towards its rest position. Resulting from the movement of first supporting layer 337, first moveable member 333 moves away from the contact member. In its first state, spring 355 may be either relaxed or compressed. When spring 355 is compressed in its first state, its compression is lower than in the second state.

Base 351, as presented in FIG. 4B, is further coupled to second supporting layer 339 via a second mechanism that is configured to retain a second predefined distance between second supporting layer 339 and base 351 when the force is not applied to the second supporting layer 339 and to move second moveable member 335 away from the contact member (not shown) when the force is no longer applied to second supporting layer 339. The second predetermined distance may be essentially the same as the first predetermined distance. The second mechanism includes two second springs 357 that are disposed between second supporting layer 339 and base 351. Base 351 includes two second pins 361 which position relatively to the longitudinal axis of base 351 corresponds to the position of second springs 357. Each second pin 361 is configured to contact its corresponding second spring 357 at one end of the spring. Second supporting layer 339 includes two second receptacles 347 which position relatively to the longitudinal axis of second supporting layer 339 corresponds to the position of second springs 357 and second pins 361. Each second receptacle 347 is configured to contact its corresponding second spring 357 at the other end of the spring. At least a first portion of second pin 361 is configured to be inserted into its corresponding second receptacle 347. At least a second portion of second pin 361 is configured to be inserted into its corresponding second receptacle 347 when the force is applied to second supporting layer 339. The second portion may be greater than the first portion. In some embodiments, second pin 361 is configured to be fully inserted into its corresponding second receptacle 347 when the force is applied to second supporting layer 339. The operating principle of the second mechanism may be essentially the same as of the first mechanism, as detailed hereinabove. In some examples no portion of second pin 361 is configured to be inserted into its corresponding second receptacle 347 when no force is applied to second supporting layer 339, and at least a portion of second pin 361 may be configured to be inserted into its corresponding second receptacle 347 when force is applied to second supporting layer 339.

The mechanism that couples the supporting layer and the base may further include a locking member configured to prevent increasing the distance between the base and the first supporting layer beyond the predefined distance. As explained hereinabove, the supporting layer is in its rest position at the predefined distance between the base and the supporting layer, and the spring is in its first state, which may be either relaxed or compressed. When the spring is compressed in the first state, it may be particularly important for the mechanism to include the locking member to retain the supporting layer in its rest position when no force is applied thereto.

Base 351, as shown in FIG. 4B includes two locking members 363 configured to prevent moving of first supporting layer 337 away from base 351 beyond the first predefined distance. Locking member 363 has a vertically extended portion and a horizontally extended portion, wherein the horizontally extended portion is configured to contact first supporting layer 337 at a side opposite to base 351, thereby preventing its movement away from base 351.

Base 351 further includes two locking members 365 configured to prevent moving of second supporting layer 339 away from base 351 beyond the second predefined distance. Locking member 365 has a vertically extended portion and a horizontally extended portion, wherein the horizontally extended portion is configured to contact second supporting layer 339 at a side opposite to base 351, thereby preventing its movement away from base 351.

The base may further comprise a stopper mechanism configured to protect the bypass mechanism from an excessive force applied to at least one of the actuators. Additionally, the stopper mechanism may protect the bypass mechanism when the force is not applied directly to the actuator. For example, the switch device of the present invention may include an inner cover at least partially encompassing the bypass mechanism, such that the first actuator, the second actuator or both extend beyond the inner cover. In certain such embodiments, the stopper mechanism may be configured to prevent bending of the inner cover when an excessive force is applied to the first actuator, the second actuator, or both, or when the force is applied to the inner cover.

Base 351, as shown in FIG. 4B includes a stopper mechanism including two pins 367 extending from base 351 towards first supporting layer 337 and second supporting layer 339. Pins 367 are positioned along the longitudinal axis of base 351 in proximity to second actuator 343. Additional pins may be positioned in proximity to first actuator 341. Second supporting layer 343 includes corresponding openings through which pins 367 are configured to pass when the second supporting layer moves towards base 351. Pins 367 extend towards the inner cover (not shown) but do not extend beyond the height of first actuator 341 and second actuator 343 and as such do not interfere with their operation. For example, when first actuator 341 and second actuator 343 comprise push buttons, pins 367 will not prevent the user from pressing the bush buttons and will not prevent first supporting layer 337 and second supporting layer 339 from moving towards base 351. However, if the user presses on the inner cover in addition to or instead of pressing the push button, pins 367 being positioned in proximity to the push button will prevent the inner cover from bending towards base 351.

The base of the bypass device may be coupled to the switch. For example, the switch may include at least one connector element. The base of the bypass device may be placed upon or connected to the at least one connector element, e.g., by means of a fastener. Additionally or alternatively, the base of the bypass device may have a shape that is complimentary to the shape of the at least one connector element, such that the base of the bypass device may be placed upon or connected to the at least one connector element without any fastening means. Coupling of the base of the bypass device to the switch may enable the contact between the moveable member and the contact member during operation of the bypass mechanism. The bypass mechanism may further include one or more placement pins to improve coupling of the bypass mechanism to the switch, enhance the alignment of the moveable member relatively to the contact member, and provide easier assembly. The placement pins may be a part of or connected to at least one of the first supporting layer, second supporting layer and base.

The switch may include a base on which the first terminal, the second terminal, and the contact member are positioned. The switch may further include one or more leading members configured to direct the movement of the first supporting layer, the second supporting layer, or both relatively to the contact member of the switch. For example, the leading member may assist in the placement of the first moveable member and/or the second moveable member when they move towards the contact member, such that they actually contact the contact member, by directing the downward movement of the first supporting layer and/or the second supporting layer, respectively. The leading members may extend from the switch base towards the first moveable member and/or the second moveable member.

The switch may include a plurality of switches, i.e., a plurality of terminal pairs comprising the first terminal and the second terminal and a plurality of contact members. The bypass mechanism may include a plurality of moveable members (or pairs of the first moveable member and the second moveable member), wherein each moveable member (or each pair) corresponds to each terminal pair and each respective contact member. Using such switch allows to either control multiple electric circuits or to improve reliability of setting or resetting of a single circuit. For example, the switch may be designed such that for the switch to open or close an electric circuit, at least two of the contact members of the switch should be either in the first position or the second position. In some embodiments, the switch is designed such that for the switch to open or close an electric circuit, at least three of the contact members of the switch should be either in the first position or the second position. In additional embodiments, the switch is designed such that for the switch to open or close an electric circuit, at least four of the contact members of the switch should be either in the first position or the second position. Additionally, the terminal pairs of the plurality of switches may be configured such that the contact members are vertically oriented when being in the first position, while to shift to the second position, contact members of some switches move towards one side and contact members of the other switches move towards the opposite side. The first surface and the second surface of the plurality of the moveable members may be designed to accommodate said arrangement of the terminal pairs. For example, the first surface of each moveable member may be designed to form the first angle with its corresponding contact member that allows to move the contact member in the intended direction to transfer it from the first position to the second position. Similarly, the second surface of each moveable member may be designed to form the second angle with its corresponding contact member that allows to move the contact member in the intended direction to transfer it from the second position to the first position. Accordingly the first angles of the plurality of the first moveable members may be different from each other and the second angles of the plurality of the second moveable members may also be different from each other. Additionally, the length of the first surfaces of plurality of the first moveable members may be different and the length of the second surfaces of plurality of the second moveable members may also be different. However, all the first moveable members (that facilitate transition of the contact member from the first position to the second position) should be coupled to the first actuator and all the second moveable members (that facilitate transition of the contact member from the second position to the first position) should be coupled to the second actuator to allow simultaneous activation of the plurality of switches by the bypass mechanism.

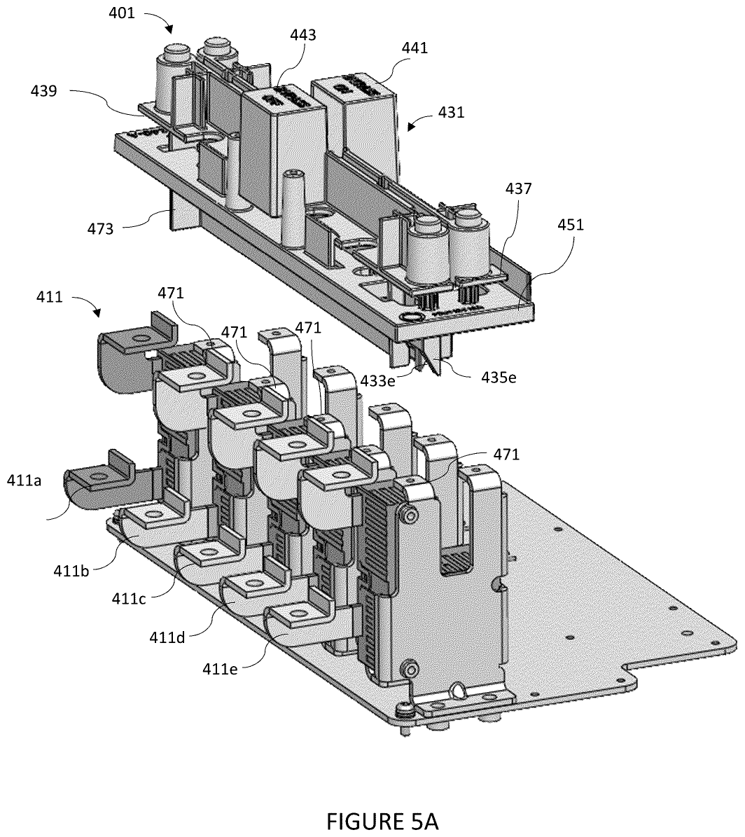

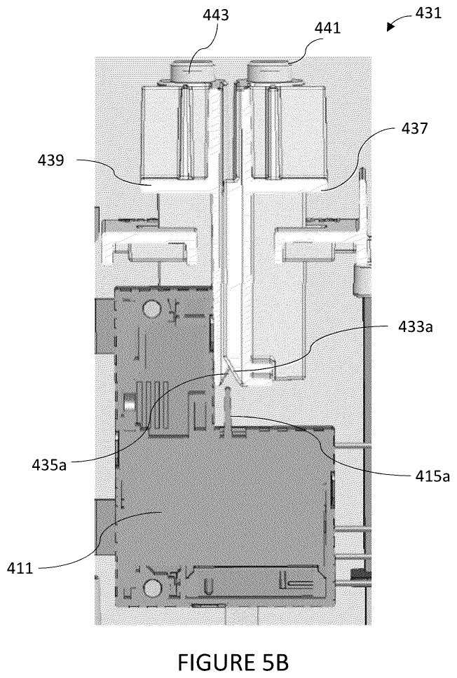

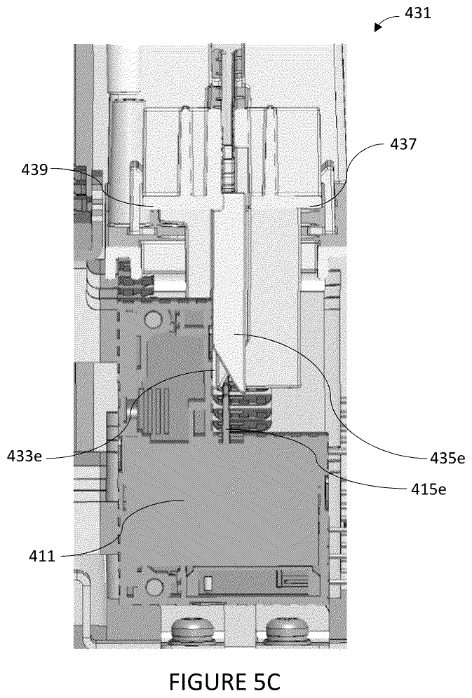

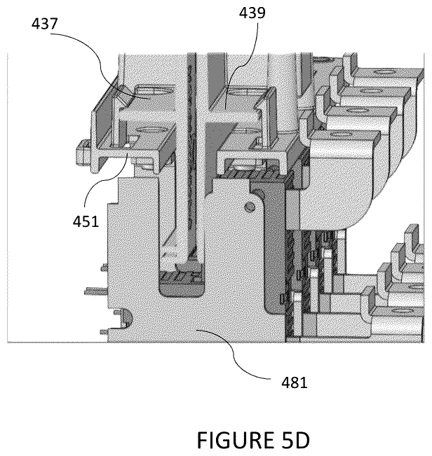

Reference is now made to FIG. 5A which schematically illustrates an exploded view of switch device 401 including switch 411 comprising a plurality of switches and bypass mechanism 431 comprising a plurality of first moveable members and second moveable members. Switch 411 includes a plurality of switches 411a, 411b, 411c, 411d, and 411e, wherein each switch comprises a terminal pair. The terminals of the terminal pairs of the plurality of switches are arranged such that the contact members of switches 411a, 411b, 411c, and 411d are configured to transition to one side to shift from the first position to the second position and the contact member of switch 411e is configured to transition to the opposite side to shift from the first position to the second position.

Bypass mechanism 431 includes a plurality of first moveable members 433 and second moveable members 435, wherein each first moveable member 433 and its adjacent second moveable member 435 correspond to their respective terminal pair (only one first moveable member 433e and one second moveable member 435e can be seen in FIG. 5A, as others are shielded from view). Bypass mechanism includes first supporting layer 437, second supporting layer 439, and base 451. The plurality of the first moveable members are coupled to a mutual first supporting layer 437 and the plurality of the second moveable members are coupled to a mutual second supporting layer 439. Additionally, the plurality of the first moveable members are coupled to a mutual first actuator 441 and the plurality of the second moveable members are coupled to a mutual second actuator 443. As such, pressing a single push button (i.e., activating first actuator 441) allows to simultaneously activate the plurality of first moveable members 433 and pressing another push button (i.e., activating a second actuator 443) allows to simultaneously activate the plurality of second moveable members 435. In some examples, separate actuators may be provided for two or more of the first moveable members or two or more of the second movable members. For example, each moveable member may have its own actuator. The lengths of the different first moveable members and the different second moveable member may be the same or different. The lengths of the first surfaces and the second surfaces may be the same or different. In some examples, a single switch may have multiple first movable members or multiple second movable members capable of moving a contact member. In some examples, a single actuator may be used to move one or more first movable members and one or more second moveable members. In some examples, one or more first moveable members may be actuated simultaneously with one or more second moveable members.

Reference is further made to FIGS. 5B and 5C, which show a cross-section of switch 411 coupled to bypass mechanism 431. FIG. 5B shows contact member 415a and its corresponding first moveable member 433a and second moveable member 435a, wherein contact member 415a is in the first position. The first surface of first moveable member 433a is configured to form a first angle with the edge of contact member 415a such that upon contact, first moveable member 433a applies force onto the edge of contact member 415a forcing it to move to the left, thereby shifting contact member 415a from the first position to the second position. First moveable member 433a is coupled to first supporting layer 437 and first actuator 441. The second surface of second moveable member 435a is configured to form a second angle with the edge of contact member 415a such that upon contact, second moveable member 435a applies force onto the edge of contact member 415a forcing it to move to the right, thereby shifting contact member 415a back from the first position to the second position. Second moveable member 435a is coupled to second supporting layer 439 and second actuator 443. As mentioned above, the lengths of the first moveable member and the second moveable member may be the same or different. As mentioned above, the lengths of the first surface and the second surface may be the same or different.

FIG. 5C shows contact member 415e and its corresponding first moveable member 433e and second moveable member 435e, wherein contact member 415e is in the first position. The first surface of first moveable member 433e is configured to form a first angle with the edge of contact member 415e such that upon contact first moveable member 433c applies force onto the edge of contact member 415e forcing it to move to the right, thereby shifting contact member 415e from the first position to the second position. First moveable member 433e is coupled to first supporting layer 437 and the first actuator. The second surface of second moveable member 435e is configured to form a second angle with the edge of contact member 415e such that upon contact, second moveable member 435e applies force onto the edge of contact member 415a forcing it to move to the left, thereby shifting contact member 415e back from the first position to the second position. Second moveable member 435e is coupled to second supporting layer 439 and the second actuator.

The first angle of first moveable member 415a is different from the first angle of first moveable angle 415e. Said angles may be supplementary angles. Using first moveable members with different orientation of the first surface allows to manipulate switches with different arrangement of the terminals by a single bypass mechanism comprising a single first actuator. The second angle of second moveable member 415a is different from the second angle of second moveable angle 415c. Said angles may be supplementary angles. Using second moveable members with different orientation of the second surface allows to manipulate switches with different arrangement of the terminals by a single bypass mechanism comprising a single second actuator.

Switch 411, as shown in FIG. 5A, further includes a plurality of connecting clements 471 configured for the attachment of bypass mechanism 431. Bypass mechanism 431 is attached to switch 411 through base 451 and connecting elements 471. First supporting layer 437 and second supporting layer 439 further include placement pins 473 configured to improve the coupling between switch 411 and bypass mechanism 431.

Reference is further made to FIG. 5D which shows a detailed view of switch 411 coupled to bypass mechanism 431. Switch 411 includes leading member 481 configured to direct the movement of first supporting layer 437, second supporting layer 439, or both relatively to the contact member of switch 411.

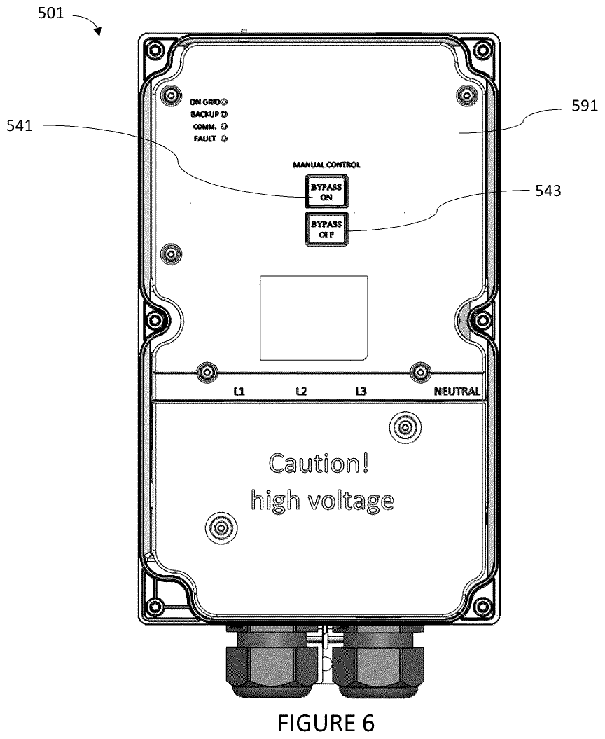

Reference is now made to FIG. 6 which schematically illustrates switch device 501 that is partially enclosed by inner cover 591. Inner cover 591 may be configured to isolate the bypass mechanism and the switch of switch device 501 from the surrounding atmosphere and protect the user from the electric circuits of the switch. However, at least a portion of first actuator 541 and a portion of second actuator 543 extend beyond inner cover 591, such that the user may activate first actuator 541 and second actuator 543 when needed.

The switch device of the present invention may further include a removeable outer cover that entirely encloses the switch and the bypass mechanism. The removeable outer cover may be removed to access the at least one actuator of the bypass mechanism.

The components of the bypass mechanism, including, inter alia, the moveable member, the supporting layer, and the base, may be made of any material that may be formed into the desired structure, e.g., a polymer or a metal. The material might not be magnetically conductive in order to avoid interference with certain components of the switch, such as the coil or permanent magnet.

Further provided is an energy generation and/or storage system comprising at least one switch device according to the various embodiments of the present invention, as described in detail hereinabove. The energy generation and/or storage system may include at least one of a power source and a power storage unit. Non-limiting examples of a suitable power source include a solar panel, wind turbine, geothermal generator, fuel cell and combustion powered generator. Non-limiting examples of a suitable power storage unit include a battery (e.g., a secondary battery), flow cell, electrolyzer, capacitor, compressed air storage system, hydraulic accumulator, and flywheel. The switch of the switch device may be configured to connect said system to at least one of a power grid and a load, and the bypass mechanism may be configured to enable connection when the switch fails to connect. Additionally or alternatively, the switch may be configured to disconnect said system from the at least one of the power grid and the load, and the bypass mechanism may be configured to enable disconnection when the switch fails to disconnect.

The energy generation and/or storage system may include at least one inverter configured to receive electrical power from the power source of the system and convert a direct current (DC) power into an alternating current (AC), wherein said inverter is electrically connected to the power source through said switch. The inverter may further be electrically connected to the power storage unit through said switch.

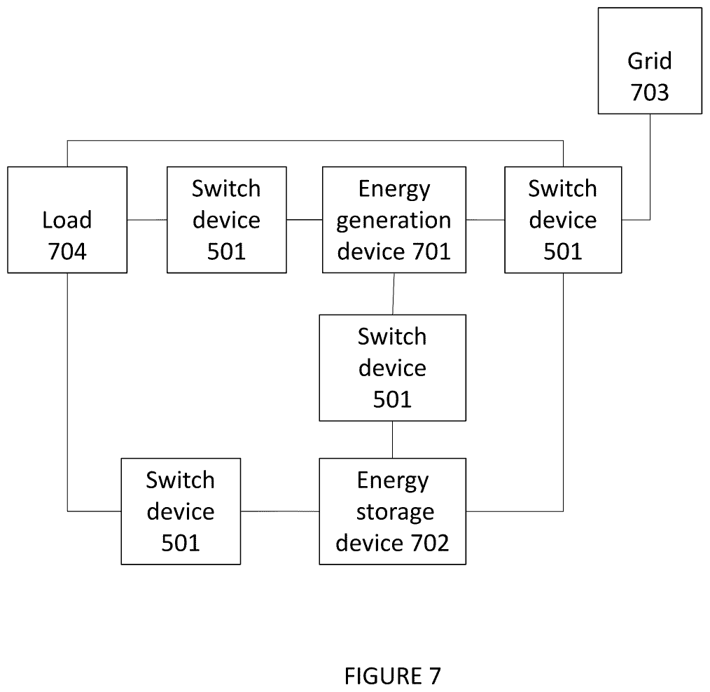

Reference is now made to FIG. 7 which schematically shows an energy generation and storage system according to some embodiments of the invention. The system includes an energy generation device 701, an energy storage device 702, and switch devices 501 as detailed in FIG. 6, wherein the energy generation device 701 and the energy storage device 702 are connected to the power grid 703 and to the load 704 via switch devices 501. Connection between the energy generation device 701 and the energy storage device 702 may also be implemented through switch device 501.

Further provided is a method of manually operating the switch of the switch device according to the various embodiments as detailed hereinabove. The method comprises activating the bypass mechanism. For example, the method may include activating the at least one actuator of the bypass mechanism. When the at least one actuator comprises a push button, the method of manually operating the switch comprises pressing the push button. The method may be used to connect the first terminal and the second terminal of the switch. The method may further be used to disconnect said first terminal from the second terminal.

The switch device of the present invention may be employed in connecting one or more energy generation and/or energy storage devices or systems to a load and/or to a grid. Said switch device may provide a switching mechanism that facilitates disconnection of said device from another device or from the grid, when required, even if the switch is not functioning. If the switch fails to perform the required action (connecting or disconnecting), the method of manually operating the switch of the switch device may be employed to circumvent the malfunctioning switch by activating the bypass mechanism. Accordingly, the present invention further provides a method of controlling connection of an energy generation and/or storage system comprising the switch device according to the various embodiments hereinabove, to at least one of a power grid and a load, wherein the method comprises activating the bypass mechanism of the switch device. For example, the method may include activating the at least one actuator of the bypass mechanism. In some embodiments, the method comprises manually disconnecting the energy generation and/or storage system from at least one of the power grid and the load, comprising activating the first actuator of the bypass mechanism. Additionally or alternatively, the method may include manually connecting the energy generation and/or storage system to at least one of the power grid and the load, comprising activating the second actuator of the bypass mechanism. In some examples, the bypass mechanism may facilitate the changing of connection of a first terminal of a first device to connection to a second terminal of a second device. For example, activating the actuator of the bypass mechanism may change the switch from connecting to a terminal of the energy generation device to connecting to a terminal of the energy storage device, or vice versa.

As used herein and in the appended claims the singular forms “a,” “an,” and “the” include plural references unless the content clearly dictates otherwise. Thus, for example, reference to “a switch” includes a plurality of such switches and equivalents thereof known to those skilled in the art, and so forth. It should be noted that the term “and” or the term “or” is generally employed in its sense including “and/or” unless the content clearly dictates otherwise.

As used herein, the term “plurality” means more than one.

As used herein, the term “about,” when referring to a measurable value such as an amount, a temporal duration, and the like, is meant to encompass variations of +/−10%, more preferably +/−5%, even more preferably +/−1%, and still more preferably +/−0.1% from the specified value, as such variations are appropriate to perform the disclosed methods.

The present application also discloses the subject matter of the following clauses.

Clause 1: An apparatus comprising:
a switch comprising:
   a first terminal;
   a second terminal;
   a contact member having an edge, the contact member being configured to be in a first position and a second position and to form a connection between the first terminal and the second terminal when being either in the first position or in the second position; and
   a control unit configured to facilitate a transition of the contact member and to retain the contact member at the first position or at the second position in the absence of an external force; and
a bypass mechanism comprising:
   at least a first moveable member having a first surface configured to contact the edge of the contact member at a first angle that is acute or obtuse.

Clause 2: The apparatus of clause 1, wherein the first moveable member is configured to move towards the edge of the contact member and to apply force thereto to facilitate its transition from the first position to the second position.

Clause 3: The apparatus of clause 2, wherein the first moveable member is configured to move away from the edge of the contact member when the force is no longer applied the first moveable member.

Clause 4: The apparatus of any one of clauses 1 to 3, wherein the bypass mechanism further comprises a second moveable member having a second surface configured to contact the edge of the contact member at a second angle that is acute or obtuse, wherein the second angle is different from the first angle.

Clause 5: The apparatus of clause 4, wherein the second moveable member is configured to move towards the edge of the contact member in response to a force applied the second moveable member and to apply force thereto to facilitate its transition from the second position to the first position.

Clause 6: The apparatus of clause 5, wherein the second moveable member is configured to move away from the edge of the contact member when the force is no longer applied to the second moveable member.

Clause 7: The apparatus of any one of clauses 1 to 6, wherein the bypass mechanism further comprises a first actuator coupled to the first moveable member, and wherein the first moveable member is configured to move towards the edge of the contact member in response to the force transmitted by the first actuator.

Clause 8: The apparatus of any one of clauses 4 to 7, wherein the bypass mechanism further comprises a second actuator coupled to the second moveable member, and wherein the second moveable member is configured to move towards the edge of the contact member in response to the force transmitted by the second actuator.

Clause 9: The apparatus of any one of clauses 1 to 6, wherein the bypass mechanism further comprises a first mechanism coupled to the first moveable member, wherein the first mechanism is configured to facilitate the movement of the first moveable member away from the edge of the contact member when the force is no longer is no longer applied to the first moveable member.

Clause 10: The apparatus of any one of clauses 4 to 9, wherein the bypass mechanism further comprises a second mechanism coupled to the second moveable member, wherein the second mechanism is configured to facilitate the movement of the second moveable member away from the edge of the contact member when the force is no longer applied to the second moveable member.

Clause 11: The apparatus of any one of clauses 7 to 10, wherein the bypass mechanism further comprises a first supporting layer, wherein the first moveable member is coupled to the first actuator through the first supporting layer.

Clause 12: The apparatus of clause 11, wherein the first moveable member has an elongated shape and wherein a longitudinal axis of the first moveable member extends between the first supporting layer and the first surface and wherein the first surface forms an acute or obtuse angle with the first supporting layer.

Clause 13: The apparatus of any one of clauses 8 to 12, wherein the bypass mechanism further comprises a second supporting layer, wherein the second moveable member is coupled to the second actuator through the second supporting layer.

Clause 14: The apparatus of clause 13, wherein the second moveable member has an elongated shape and wherein a longitudinal axis of the second moveable member extends between the second supporting layer and the second surface and wherein the second surface forms an acute or obtuse angle with the second supporting layer.

Clause 15: The apparatus of any one of clauses 11 to 14, wherein the first moveable member is configured to move towards the edge of the contact member in response to a force applied to the first supporting layer.

Clause 16: The apparatus of clause 15, wherein the first moveable member is configured to move away from the edge of the contact member when the force is no longer applied to the first supporting layer.

Clause 17: The apparatus of any one of clauses 13 to 16, wherein the second moveable member is configured to move towards the edge of the contact member in response to a force applied to the second supporting layer.

Clause 18: The apparatus of clause 17, wherein the second moveable member is configured to move away from the edge of the contact member when the force is no longer applied to the second supporting layer.

Clause 19: The apparatus of any one of clauses 13 to 18, wherein the first supporting layer is disposed adjacently to the second supporting layer and the first moveable member is disposed adjacently to the second moveable member when the force is not applied to the first supporting layer and to the second supporting layer.

Clause 20: The apparatus of any one of clauses 4 to 19, wherein each one of the first angle and the second angle, individually, range between about 10° to about 80° or between about 100° to about 170°.

Clause 21: The apparatus of any one of clauses 4 to 20, wherein the first angle and the second angle are supplementary angles.

Clause 22: The apparatus of any one of clauses 1 to 21, wherein a ratio between a length of the first surface and a length of the edge of the contact member is at least 1.5:1.

Clause 23: The apparatus of any one of clauses 4 to 22, wherein a ratio between a length of the second surface and a length of the edge of the contact member is at least about 1.5:1.

Clause 24: The apparatus any one of clauses 7 to 23, wherein the first actuator is configured to facilitate a movement of the first moveable member in response to a signal received from a user.

Clause 25: The apparatus of any one of clauses 10 to 24, wherein the second actuator is configured to facilitate a movement of the second moveable member in response to a signal received from a user.

Clause 26: The apparatus of any one of clauses 10 to 25, wherein the first actuator, the second actuator, or both comprise at least one of a push button, pressure sensor, touch pad, electric actuator, hydraulic actuator, and pneumatic actuator.

Clause 27: The apparatus of clause 26, wherein the first actuator comprises a first push button, wherein said first push button is an integral part of the first supporting layer, and wherein application of the force to the first push button displaces the first supporting layer from its rest position and facilitates the movement of the first moveable member towards the contact member.

Clause 28: The apparatus of any one of clauses 26 or 27, wherein the second actuator comprises a second push button, wherein said second push button is an integral part of the second supporting layer, and wherein application of the force to the second push button displaces the second supporting layer from its rest position and facilitates the movement of the second moveable member towards the contact member.

Clause 29: The apparatus of any one of clauses 11 to 28, wherein the bypass mechanism further comprises a base that is complimentary to the first supporting layer and the first moveable member.

Clause 30: The apparatus of any one of clauses 13 to 29, wherein the base is further complimentary to the second supporting layer and the second moveable member. Clause 31: The apparatus of any one of clauses 29 or 30, wherein the first supporting layer and the base are coupled through the first mechanism that is configured to retain a first predefined distance between the first supporting layer and the base when the force is not applied to the first supporting layer.

Clause 32: The apparatus of any one of clauses 29 to 31, wherein the second supporting layer and the base are coupled through the second mechanism that is configured to retain a second predefined distance between the second supporting layer and the base when the force is not applied to the second supporting layer.

Clause 33: The apparatus of any one of clauses 9, 10, 31 and 32, wherein the first mechanism, the second mechanism, or both comprise at least one of an elastically compressible member, an inflatable member, a hydraulic actuator, a pneumatic actuator and a magnetic actuator.

Clause 34: The apparatus of any one of clauses 31 to 33, wherein the first mechanism further comprises a locking member configured to prevent increasing the distance between the base and the first supporting layer beyond the first predefined distance.

Clause 35: The apparatus of any one of clauses 32 to 34, wherein the second mechanism further comprises a locking member configured to prevent increasing the distance between the base and the second supporting layer beyond the second predefined distance.

Clause 36: The apparatus of any one of clauses 8 to 35, further comprising an inner cover partially enclosing the bypass mechanism, such that the first actuator, the second actuator or both extend beyond the inner cover.

Clause 37: The apparatus of clause 36, wherein the base further comprises a stopper mechanism configured to prevent bending of the inner cover when an excessive force is applied to the first actuator, the second actuator, or both, or when the force is applied to the inner cover. Clause 38: The apparatus of any one of clauses 36 or 37, wherein the stopper mechanism comprises one or more pins extending from the base and positioned in proximity to the first actuator, the second actuator, or both.

Clause 39: The apparatus of any one of clauses 29 to 38, wherein the base is coupled to the switch.

Clause 40: The apparatus of any one of clauses 1 to 39, wherein the switch comprises a plurality of terminal pairs comprising the first terminal and the second terminal and the bypass mechanism comprises a plurality of first movable members, wherein each first moveable member corresponds to each terminal pair.

Clause 41: The apparatus of clause 40, wherein the bypass mechanism further comprises a plurality of second moveable members that are disposed adjacently to the plurality of second moveable members, wherein each first moveable member and its adjacent second moveable member correspond to each terminal pair.

Clause 42: The apparatus of any one of clauses 5 to 37, comprising a plurality of switches, a plurality of first movable members, and a plurality of second moveable members, wherein each first moveable member and its corresponding second moveable member correspond to each switch, and wherein the plurality of first movable members are coupled to a mutual first actuator and the plurality of second moveable members are coupled to a mutual second actuator.

Clause 43: The apparatus of any one of clauses 1 to 42, wherein the control unit comprises an electromagnetic circuit that is configured to facilitate the transition of the contact member.

Clause 44: The apparatus of any one of clauses 1 to 43, wherein the control unit further comprises a retaining component coupled to the contact member that is configured to retain the contact member stable at the first position or the second position in the absence of an external force applied to the contact member.

Clause 45: The apparatus of clause 44, wherein the retaining component is selected from an electromagnetic component or mechanic component.

Clause 46: The apparatus of any one of clauses 1 to 45, wherein the switch is a latching relay.

Clause 47: The apparatus of any one of clauses 1 to 46, further comprising a removeable outer cover that entirely encloses the switch and the bypass mechanism.

Clause 48: An energy generation and/or storage system comprising the apparatus of any one of clauses 1 to 47, wherein the switch is configured to connect said system to at least one of a power grid and a load, and wherein the bypass mechanism is configured to enable connection when the switch fails to connect.

Clause 49: An energy generation and/or storage system comprising the apparatus of any one of clauses 1 to 48, wherein the switch is configured to disconnect said system from the at least one of the power grid and the load, and wherein the bypass mechanism is configured to enable disconnection when the switch fails to disconnect.

Clause 50: An energy generation and/or storage system comprising the apparatus of any one of clauses 1 to 49, wherein the switch is configured to connect said system to at least one of a power grid and a load and to disconnect said system therefrom, and wherein the bypass mechanism is configured to enable connection when the switch fails to connect and to enable disconnection when the switch fails to disconnect.

Clause 51: The energy generation and/or storage system of any one of clauses 48 to 50, wherein said system comprises at least one inverter configured to receive electrical power from a power source of the system and convert a direct current (DC) power into an alternating current (AC), wherein said inverter is electrically connected to the switch.

Clause 52: A method of manually operating the switch of the apparatus according to any one of clauses 8 to 47, comprising activating the first actuator, the second actuator, or both.

Clause 53: A method of disconnecting an energy generation and/or storage system comprising the apparatus of any one of clauses 7 to 47, from at least one of a power grid and a load, the method comprising activating the first actuator.

Clause 54: A method of connecting an energy generation and/or storage system comprising the apparatus of any one of clauses 8 to 47, to at least one of a power grid and a load, the method comprising activating the second actuator.

Clause 55: An apparatus comprising:
a switch comprising:
a first terminal;
a second terminal;
a contact member having an engagement portion, the contact member being configured to be in a first position and a second position and to form a connection between the first terminal and the second terminal when being either in the first position or in the second position; and
a control unit configured to facilitate a transition of the contact member and to retain the contact member at the first position or at the second position in the absence of an external force; and a bypass mechanism comprising:
a first moveable member, having an engagement portion, configured to move in a first direction towards the contact member, such that the engagement portion of the first moveable member contacts the engagement portion of the contact member and applies a component of force thereto in a second direction, which is different from the first direction, that facilitates the transition of the contact member from the first position to the second position.

Clause 56: The apparatus of clause 55, wherein the contact member comprises first and second major faces connected by an edge that constitutes the engagement portion of the contact member.

Clause 57: The apparatus of clause 56, wherein the engagement portion of the first moveable member contacts the engagement portion of the contact member at a first angle that is acute or obtuse relative to an axis that is perpendicular to a longitudinal axis of the contact member.

Clause 58: The apparatus of clause 55, wherein the contact member comprises a rod having an end portion that constitutes the engagement portion of the contact member.

While the present invention has been particularly described, persons skilled in the art will appreciate that many variations and modifications can be made. Therefore, the invention is not to be construed as restricted to the particularly described embodiments, and the scope and concept of the invention will be more readily understood by reference to the claims, which follow.

What is claimed is:

1. An apparatus comprising:
a switch comprising:
a first terminal;
a second terminal;
a contact member having an engagement portion, the contact member being configured to be in a first position and a second position and to form a connection between the first terminal and the second terminal when being either in the first position or in the second position; and
a control unit configured to facilitate a transition of the contact member and to retain the contact member at the first position or at the second position in the absence of an external force; and
a bypass mechanism comprising:
at least a first moveable member having a first surface configured to contact the engagement portion of the contact member at a first angle that is acute or obtuse relative to an axis that is perpendicular to a longitudinal axis of the contact member.

2. The apparatus of claim 1, wherein the first moveable member is configured to move towards the engagement portion of the contact member and to apply force thereto to facilitate its transition from the first position to the second position.

3. The apparatus of claim 2, wherein the first moveable member is configured to move away from the engagement portion of the contact member when the force is no longer applied to the first moveable member.

4. The apparatus of claim 1, wherein the bypass mechanism further comprises a second moveable member having a second surface configured to contact the engagement portion of the contact member at a second angle that is acute or obtuse relative to the axis, wherein the second angle is different from the first angle.

5. The apparatus of claim 4, wherein the second moveable member is configured to move towards the engagement portion of the contact member in response to a force applied to the second moveable member and to apply force thereto to facilitate its transition from the second position to the first position.

6. The apparatus of claim 5, wherein the second moveable member is configured to move away from the engagement portion of the contact member when the force is no longer applied to the second moveable member.

7. The apparatus of claim 1, wherein the bypass mechanism further comprises a first actuator coupled to the first moveable member, and wherein the first moveable member is configured to move towards the engagement portion of the contact member in response to the external force transmitted by the first actuator.

8. The apparatus of claim 4, wherein the bypass mechanism further comprises a second actuator coupled to the second moveable member, and wherein the second moveable member is configured to move towards the engagement portion of the contact member in response to the external force transmitted by the second actuator.

9. The apparatus of claim 1, wherein the bypass mechanism further comprises a first mechanism coupled to the first moveable member, wherein the first mechanism is configured to facilitate movement of the first moveable member away from the engagement portion of the contact member when the external force is no longer applied to the first moveable member.

10. The apparatus of claim 4, wherein the bypass mechanism further comprises a second mechanism coupled to the second moveable member, wherein the second mechanism is configured to facilitate movement of the second moveable member away from the engagement portion of the contact member when the external force is no longer applied to the second moveable member.

11. The apparatus of claim 7, wherein the bypass mechanism further comprises a first supporting layer, wherein the first moveable member is coupled to the first actuator through the first supporting layer.

12. The apparatus of claim 11, wherein the first moveable member has an elongated shape and wherein a longitudinal axis of the first moveable member extends between the first supporting layer and the first surface and wherein the first angle is acute or obtuse relative to the first supporting layer.

13. The apparatus of claim 8, wherein the bypass mechanism further comprises a second supporting layer, wherein the second moveable member is coupled to the second actuator through the second supporting layer.

14. The apparatus of claim 13, wherein the second moveable member has an elongated shape and wherein a longitudinal axis of the second moveable member extends between the second supporting layer and the second surface and wherein the second angle is acute or obtuse relative to the second supporting layer.

15. The apparatus of claim 11, wherein the first moveable member is configured to move towards the engagement portion of the contact member in response to a force applied to the first supporting layer.

16. The apparatus of claim 15, wherein the first moveable member is configured to move away from the engagement portion of the contact member when the force is no longer applied to the first supporting layer.

17. The apparatus of claim 13, wherein the second moveable member is configured to move towards the engagement portion of the contact member in response to a force applied to the second supporting layer.

18. The apparatus of claim 17, wherein the second moveable member is configured to move away from the engagement portion of the contact member when the force is no longer applied to the second supporting layer.

19. The apparatus of claim 13, wherein:
wherein the bypass mechanism further comprises a first supporting layer,
the bypass mechanism further comprises a base that is complimentary to the first supporting layer, the first moveable member, the second supporting layer, and the second moveable member,
the first supporting layer and the base are coupled through a first mechanism that is configured to retain a first predefined distance between the first supporting layer and the base when the external force is not applied to the first supporting layer, and
the second supporting layer and the base are coupled through a second mechanism that is configured to retain a second predefined distance between the second supporting layer and the base when the external force is not applied to the second supporting layer.

20. The apparatus of claim 4, comprising a plurality of switches, a plurality of first moveable members, and a plurality of second moveable members, wherein each first moveable member and its corresponding second moveable member correspond to each switch, and wherein the plurality of first moveable members are coupled to a mutual first actuator and the plurality of second moveable members are coupled to a mutual second actuator.
